(19) United States
(12) Patent Application Publication
(10) Pub. No.: US 2012/0110291 A1
(43) Pub. Date: May 3, 2012

(54) SYSTEM AND METHOD FOR I/O COMMAND MANAGEMENT

(75) Inventors: Erez Zilber, Zichron Yaakov (IL); Guy Keren, Haifa (IL); Benny Koren, Zichron Yakov (IL)

(73) Assignee: KAMINARIO TECHNOLOGIES LTD., Yokne'am ILIT (IL)

(21) Appl. No.: 13/262,867

(22) PCT Filed: Mar. 6, 2010
(86) PCT No.: PCT/IL2010/000288

§ 371 Date: Jan. 19, 2012

Related U.S. Application Data
(60) Provisional application No. 61/166,931, filed on Apr. 6, 2009.

(51) Int. Cl. G06F 12/14

(52) U.S. Cl. 711/163; 711/E12.094

(57) ABSTRACT

Systems and methods for input/output command management. In embodiments of the invention an input/output command fully executes after a lock has been obtained for the command on all storage segments relating to the command, in a predetermined order. Some embodiments of the invention allow overlapping access to storage and/or to individual storage segments by a plurality of input/output commands. In some embodiments of the invention, prioritization of commands is facilitated through the usage of a sharing policy and/or wakeup policy.

### FIELD OF THE INVENTION

The present invention relates to the field of storage.

### BACKGROUND OF THE INVENTION

A typical storage includes a plurality of storage segments. When a read command is received, data is read from one or more of these storage segments. When a write command is received, data is written to one or more of these storage segments. Assuming a limitation where an input/output command is allowed to be generated and/or received only after a previous input/output command has been completed, there will be no overlapping access to the storage relating to commands. However this limitation may in some cases be difficult to implement, for example if there are multiple sources generating input/output commands without awareness of command generation by one another. Additionally, this limitation may in some cases be unnecessary and therefore inefficient, because two different commands may relate to completely different storage segments and therefore overlapping access to the storage would not mean overlapping access to individual storage segments. Furthermore, this limitation does not allow prioritization of commands according to a policy tailored for a particular system. Instead the limitation results in prioritization according to first in first out FIFO access for the commands which may not always be appropriate.

### SUMMARY OF THE INVENTION

According to some embodiments of the invention there is provided a method of managing input/output commands comprising: in a predetermined order, attempting to obtain a lock for a received input/output command on all of a plurality of storage segments relating to the command; if during the attempting a lock cannot be obtained on a storage segment in the plurality because of an already existing lock which will not be shared with the command, then waiting until a lock can be obtained for the command and after obtaining the lock, attempting to obtain a lock on a next storage segment in the predetermined order; wherein the command is performed only after a lock has been obtained for the command on all of the plurality of storage segments.

According to the present invention, there is provided a system for managing input/output commands comprising: at least one storage comprising storage segments; and at least one controller configured to receive input/output commands generated by at least one command generator, and for each input/output command configured to attempt to obtain a lock on all of a plurality of storage segments related to the command in a predetermined order, and if during the attempting a lock cannot be obtained on a storage segment in the plurality because of an already existing lock which will not be shared with the command, then further configured to wait until a lock can be obtained for the command and after obtaining the lock, to attempt to obtain a lock on a next storage segment in the predetermined order; the at least one controller further configured to perform the command after a lock has been obtained on all storage segments related to the command.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a high level block diagram of a system for generating and managing input/output commands, according to some embodiments of the invention;

FIG. 2 is a flowchart illustration of a method for managing input/output commands, according to some embodiments of the invention;

FIG. 3 is a flowchart illustration of an unlocking sub-method of the method illustrated in FIG. 2, according to some embodiments of the invention;

FIG. 4 is a more detailed block diagram of a system for generating and managing input/output commands, according to some embodiments of the invention;

FIG. 5 is a flowchart illustration of a method of managing access to storage segments, according to some embodiments of the invention; and

FIG. 6 is a high level block diagram of an implementation of a system for generating and managing input/output commands, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In embodiments of the present invention an input/output command fully executes after a lock has been obtained for the command on all storage segments relating to the command, in a predetermined order. Some embodiments of the invention allow overlapping access to storage and/or to individual storage segments by a plurality of input/output commands. In some embodiments of the invention, prioritization of commands is facilitated through the usage of a sharing policy and/or wakeup policy.

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

As used herein, the phrase “for example,” “such as”, “for instance” and variants thereof describe non-limiting embodiments of the present invention.

Reference in the specification to “one embodiment”, “an embodiment”, “some embodiments”, “another embodiment”, “other embodiments”, “one instance”, “some instances”, “one case”, “some cases”, “other cases” or variants thereof means that a particular feature, structure or characteristic described in connection with the embodiment(s) is included in at least one embodiment of the invention. Thus the appearance of the phrase “one embodiment”, “an embodiment”, “some embodiments”, “another embodiment”, “other embodiments” one instance”, “some instances”, “one case”, “some cases”, “other cases” or variants thereof does not necessarily refer to the same embodiment(s).

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Unless specifically stated otherwise, as apparent from the following discussions, it is appreciated that throughout the specification discussions utilizing terms such as “managing”, “searching”, “receiving”, “attempting”, performing”, “obtaining”, “releasing”. “waiting”, “sharing”, “checking”, “hashing”, “determining”, “generating”, “queuing”, “discarding”, “storing”, “keeping count”, “causing”, “issuing”, “initiating”, “processing”, “computing”, “calculating”, “assigning” or the like, refer to the action and/or processes of any combination of software, hardware and/or firmware. For example, these terms may refer in some cases to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Throughout the description of the present invention, reference is made to the term “storage segment” or simply to “segment”. Unless explicitly stated otherwise, the term “storage segment”, “segment” or variants thereof shall be used to describe a physical unit that is accessed as a unit in a particular storage. For example, in one type of storage, each block may be a separate storage segment. However this example should not be construed as limiting, and storage segments may be of any size, and even of different sizes within the same storage.

Throughout the description of the present invention, reference is made to the term “input/output command”, aka “I/O command”, or simply to “command”. Unless explicitly stated otherwise, the term “I/O command”, “command”, or variants thereof shall be used to describe an instruction which refers to one or more storage segments. Typical types of I/O command include a read command that commands the retrieval of data that is stored within storage, and a write command that commands the storing of data within storage or the updating of existing data within storage. A read command is an example of a command which does not change the content in storage (“non-content changing command”) whereas a write command is an example of a command which changes the content in storage (“content changing command”). It would be appreciated, that many storage interface protocols include different variants on the I/O commands, but often such variants are essentially some form of the basic read and write commands. Examples of storage interface protocols include inter-alia: Small Computer System Interface (SCSi), Fibre Channel (FC), Fibre Channel over Ethernet (FCoE), Internet SCSI (iSCSI), Serial Attached SCSI (SAS), Enterprise System Connectivity (ESCON), Fibre Connectivity (FICON), Advance Technology, Attachment (ATA), Serial ATA (SATA), Parallel ATA (PATA), Fibre ATA (FATA), ATA over Ethernet (AoE). By way of example, the SCSI protocol will be referred to below even though other protocols may be used. The SCSI protocol supports read and write commands on different block sizes, but it also has variants such as the verify command which is defined to read data and then compare the data to an expected value. Further by way of example, the SCSI protocol supports a write-and-verify command which is effective for causing the storage of the data to which the command relates, the reading of the stored data, and the verification that the correct value was stored.

Throughout the description, reference is made to the term “overlapping access”. Unless explicitly stated otherwise, the term “overlapping access” or variants thereof, refers to accesses by at least two commands which are at least partly concurrent. For example, assuming two accesses, in one embodiment the two accesses may be simultaneous, whereas in another embodiment one of the accesses may begin and/or end at a different time than the other.

Throughout the description reference is made to “obtaining a lock on a storage segment”, or “locking a storage segment”. Unless explicitly stated otherwise, “obtaining a lock on a storage segment”, “locking a storage segment” or variants thereof describe the reservation of access to a storage segment. Depending on the embodiment, the reserved access to (i.e. the lock on) a segment may be exclusive or non-exclusive. If the lock is exclusive, overlapping access to the storage segment is not allowed. Similarly, unless specifically stated otherwise, “unlocking a storage segment”, or variants thereof, describe the removal of restrictions on access to a storage segment. Therefore, unless specifically stated otherwise, a “locked storage segment” refers to a storage segment whose access is either exclusively or non-exclusively reserved.

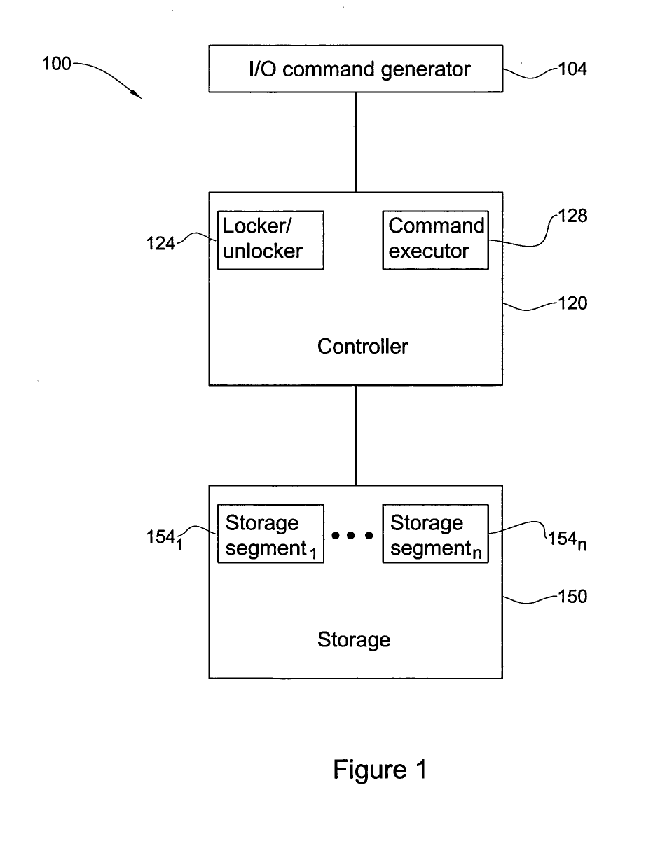

Referring now to the drawings, FIG. 1 is a high level block diagram of a system 100 for generating and managing I/O commands, according to some embodiments of the invention. In the illustrated embodiment, system 100 includes one or more storages 150 configured at least to store n storage segments 154 (of which two are explicitly shown, storage segment₁ 154₁ and storage segmentₙ 154ₙ); one or more input/output I/O command generators 104 which are configured at least to generate I/O commands; and one or more controllers 120 which are configured at least to manage the generated I/O commands, in some cases even allowing overlapping access to storage(s) 150. Each I/O command generator 104, storage 150, and controller 120 may be made up of any combination of software, hardware and/or firmware capable of performing the operations as defined and explained herein. The invention does not place a minimum or maximum limit on the number n of storage segments and n can therefore equal any appropriate number. The invention also does not restrict the size of a storage segment. Depending on the embodiment, each of the n storage segments may necessarily be the same size, or each of the n storage segments are not necessarily the same size.

The modules in system 100 may be centralized in one location or dispersed over more than one location. In some embodiments, system 100 may comprise fewer, more, and/or different modules than those shown in FIG. 1. In some embodiments, the functionality of system 100 described herein may be divided differently among the modules of FIG. 1. In some embodiments, the functionality of system 100 described herein may be divided into fewer, more and/or different modules than shown in FIG. 1 and/or system 100 may include additional or less functionality than described herein. For example, in some cases system 100 may include additional modules unrelated to the generation and performance of I/O commands.

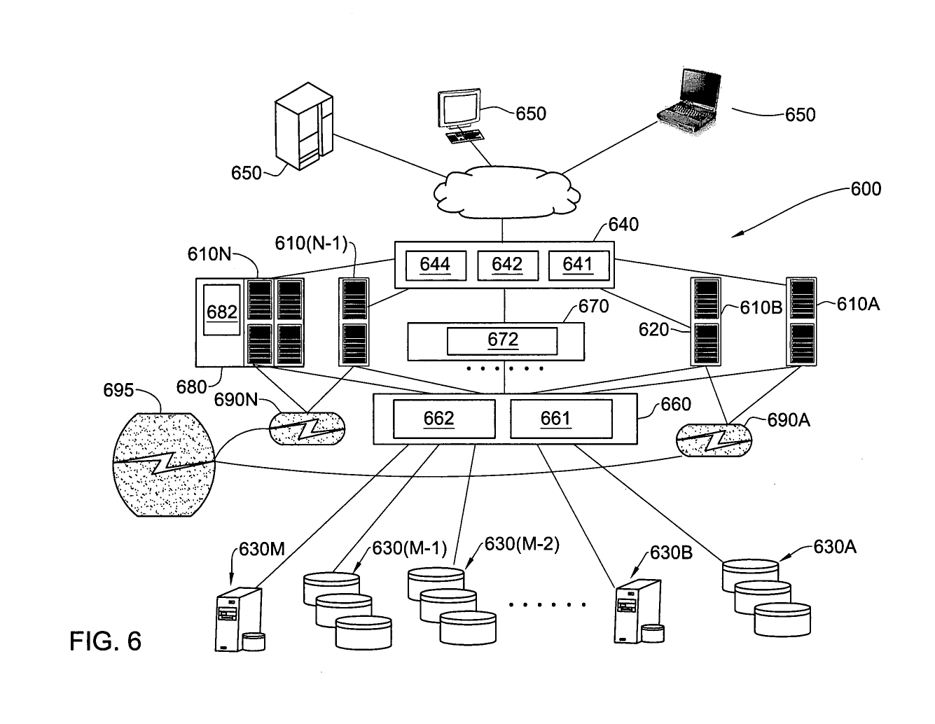

The invention is not limited to a particular type of I/O command generator 104. Examples of I/O command generators 104 which can generate an I/O command include inter-alia an entity such as a host which does not participate in the management of I/O commands, or an entity such an a controller which participates in the management of other I/O commands (see for example below description of one implementation with reference to FIG. 6) etc. The invention is also not limited to a particular communication means or protocol for transferring generated I/O commands between I/O command generator(s) 104 and controller(s) 120. Examples of possible transfer means include any known or future transfer means. Continuing with the examples, in various embodiments possible transfer means may be remote or local, wired or wireless, etc. One example of a possible protocol which may be used in the transfer is the SCSI protocol, but other embodiments may use other protocols. The invention is also not limited to a particular format for I/O commands. For example, in one embodiment a received write command may include the data to be written to storage(s) 150, whereas in other embodiments, the write command may not include the data to be written. In these latter embodiments, the data to be written may for example be retrieved by controller(s) 120, or for example, may be transferred to controller 120 separately from the command.

For the sake of example, assume that a particular controller or group of controllers 120 has/have received a plurality of input/output commands. In one embodiment, these commands may have been generated by one input/output command generator 104, whereas in another embodiment, these commands may have been generated by a plurality of input/output command generators 104.

As illustrated in FIG. 1 controller(s) 120 include(s) a locker/unlocker module 124 and/or a command executor module 128. In some embodiments, locker/unlocker module 124 is configured at least to lock/unlock various storage segments 154. In some embodiments, command executor module 128 is configured at least to receive an I/O command and to perform the command once all storage segments relating to the command have been locked. In some embodiments, controller(s) 120 may comprise fewer, more and/or different modules than illustrated in FIG. 1. In some embodiments, controller 120 may include additional or less functionality than described herein. For example, in some cases controller 120 may include additional functionality unrelated to managing I/O commands.

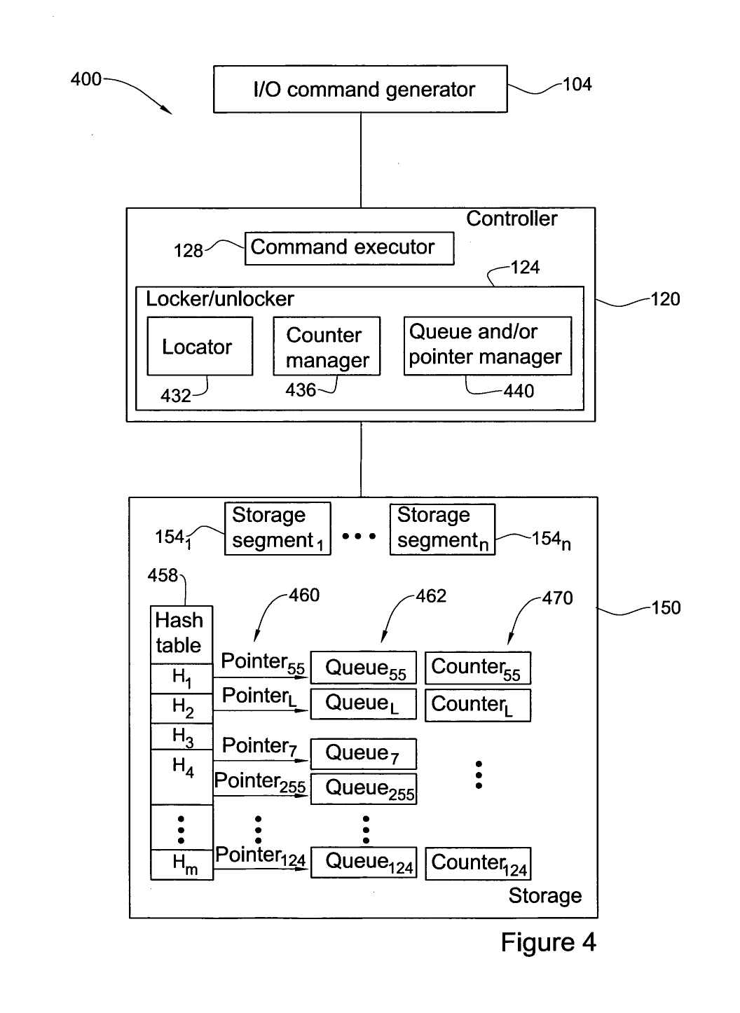

In some embodiments, the functionality of locker/unlocker module 124 and command executor module 128 described herein below may be divided into fewer, more and/or different modules. In some embodiments of the invention, locker/unlocker module 124 and/or command executor module 128 may have more, less and/or different functionality than described herein, and/or the functionality described herein may be divided differently among modules 124 and 128. As an example of different modules, a function ascribed herein to locker/unlocker module 124 may in some instances be performed by command executor 128 and/or vice versa. As an example of a larger number of modules, locker/unlocker module 124 may in some instances be divided into separate modules for performing functions related to locking and for performing functions related to unlocking. As another example of a larger number of modules, command executor module 128 may additionally or alternatively in some instances be divided into separate modules for command receiving functions and command performing functions. For an additional or alternative example of a larger number of modules, see below description of FIG. 4.

In some embodiments, there may be a single controller 120 carrying out the functions ascribed herein generally to controller 120 or more specifically to particular modules within controller 120. However, in some embodiments there may be a plurality of controllers 120 collectively carrying out the functions ascribed herein generally to controller 120 or more specifically to modules within controller 120. For example, in some of these embodiments, one or more controllers 120 may comprise command executor module 128 and one or more other controllers 120 may comprise locker/unlocker module 124. In another example, in some of these embodiments additionally or alternatively, command executor module 128 may comprise one or more controllers. Continuing with the example, in one embodiment, command executor module 128 may comprise separate individual controllers or separate pluralities of controllers responsible for various command subsets (with each command subset including at least one command). In the same example, in another embodiment, command executor module 128 may alternatively comprise one controller or a plurality of controllers responsible for all commands, without particular assignment. In some cases with separate controllers or pluralities of controllers responsible for various commands, command executor module 128 may additionally comprise one or a plurality of controllers responsible for all commands, for instance for coordinating among the separate controllers or pluralities of controllers. Therefore, depending on the embodiment, command executor module 128 may comprise one or a plurality of controllers responsible for all commands, separate individual controllers or pluralities of controllers responsible for different commands, or a combination thereof. In embodiments where command executor module 128 includes separate individual controllers or separate pluralities of controllers responsible for different command subsets (in addition to or instead of controller(s) responsible for all commands), when reference is made below to action by command executor 128 involving a specific command, it should be understood to refer to the specific controller or controllers assigned to the subset which includes that command (in addition to or instead of controller(s) responsible for all commands), and not to controller(s) assigned to other subsets.

In another example, in some of these embodiments, additionally or alternatively, locker/unlocker module 124 may comprise one or more controllers Continuing with the example, in one embodiment, locker/unlocker module 124 may comprise separate individual controllers or separate pluralities of controllers responsible for various assigned storage segment subsets (with each storage segment subset including at least one storage segment). In the same example, in another embodiment, locker/unlocker module 124 may alternatively comprise one controller or a plurality of controllers responsible for all of the n storage segments, without particular assignment. In some cases with separate controllers or pluralities of controllers responsible for various storage segment subsets, locker/unlocker module 124 may additionally comprise one or a plurality of controllers responsible for all n storage segments, for instance for coordinating among the separate controllers or pluralities of controllers. Therefore, depending on the embodiment, locker/unlocker module 124 may comprise one or a plurality of controllers responsible for all segments, separate individual controllers or pluralities of controllers responsible for different segments, or a combination thereof. In embodiments where locker/unlocker module 124 includes separate individual controllers or separate pluralities of controllers responsible for different segment subsets (in addition to or instead of controller(s) responsible for all segments), when reference is made below to action by locker/unlocker module 124 involving a specific storage segment, it should be understood to refer to the specific controller or controllers assigned to the subset which includes that segment (in addition to or instead of controller(s) responsible for all segments), and not to controller(s) assigned to other storage subsets.

In some embodiments where locker/unlocker module 124 comprises a plurality of controllers responsible for all n storage segments, controllers may be assigned various command subsets (with each command subset including at least one command). In other embodiments, the one or a plurality of controllers responsible for all n storage segments may be responsible for all commands. In embodiments where locker/unlocker module 124 includes controllers responsible for different command subsets among the controller(s) responsible for all segments, when reference is made below to activity by locker/unlocker module 124 involving a specific command, it should be understood to refer to the specific controller or controller assigned to the subset which includes that command (in addition to or instead of controller(s) responsible for the segment subset) and not to controller(s) assigned to other command subsets.

In some embodiments with separate controllers or pluralities of controllers responsible for various storage segment subsets, the existence of a particular controller may be unrelated to whether or not there is a lock on a storage segment that is the responsibility of the particular controller. In other embodiments, however, the particular controller may be dynamic, for example created when first a storage segment for which the particular controller is responsible is to be locked and then discarded when there are no longer locked storage segments nor waiting commands for those storage segments for which that particular controller is responsible. In still other embodiments, however, a particular controller may be created when first a storage segment for which the particular controller is responsible is to be locked with a lock which at least in some cases may be shared under the sharing policy. In these embodiments, the particular controller may be discarded when there are no longer locked segments for which the particular controller is responsible, whose lock can be shared at least in some cases under the sharing policy.

In some embodiments with separate controllers or pluralities of controllers responsible for various command subsets, a particular controller may exist before command(s) in the command subset have been received and/or after command(s) in the command subset have been performed. In other embodiments, however, the particular controller may be dynamic, for example created when first a command for which the particular controller is responsible is received and then discarded when all commands for which the particular controller is responsible have been performed.

In one embodiment, there may be one storage 150. In another embodiment there may be more than one storage 150, for example as described below with reference to FIG. 6. In some embodiments, storage(s) 150 may be used for storing information relating to controller operation, for example as described with reference to FIG. 4 below.

For simplicity of description, unless explicitly stated otherwise, the single form of I/O command generator 104, storage 150, and controller 120 is used below to include both embodiments with one I/O command generator 104, one storage 150, and one controller 120 and embodiments with a plurality of I/O command generators 104, storages 150, and/or controllers 120.

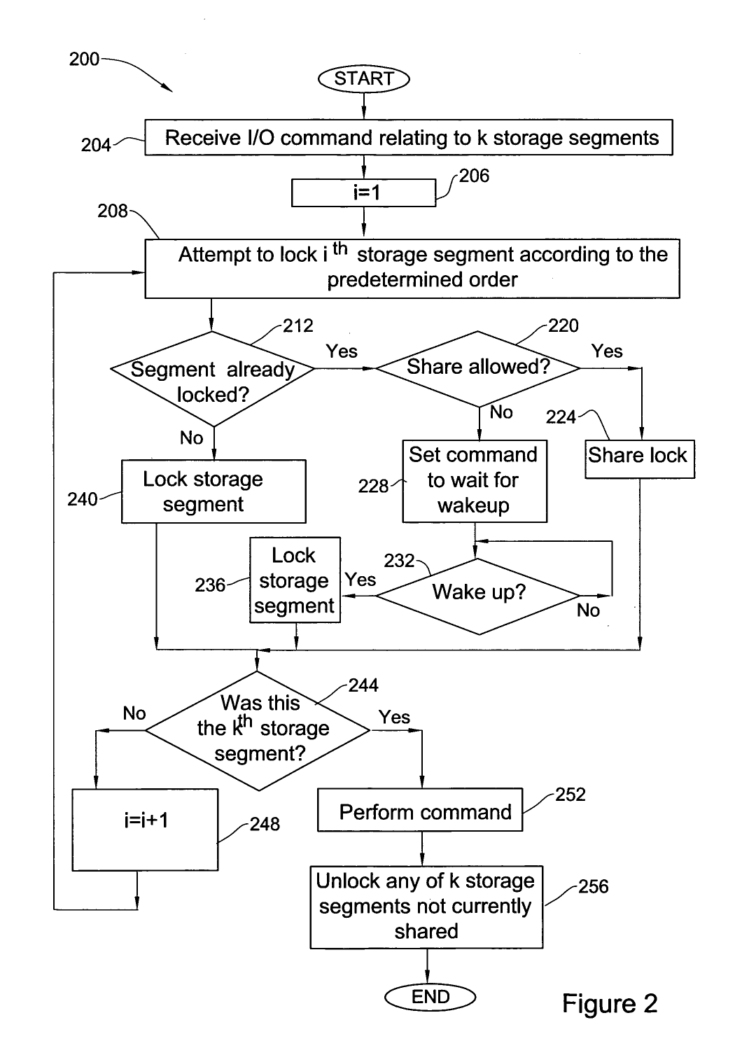

FIG. 2 is a flowchart illustration of a method 200 for managing input/output commands, according to some embodiments of the invention. In one embodiment, method 200 is performed by controller 120. In some cases, method 200 may include fewer, more and/or different stages than illustrated in FIG. 2, the stages may be executed in a different order than shown in FIG. 2, and/or stages that are illustrated as being executed sequentially may be executed in parallel.

In the illustrated embodiments, overlapping access to storage 150 by various I/O commands is permitted by method 200. However a particular I/O command is performed only once a lock on all storage segments relating to the command has been obtained. Therefore, partial execution of the command is avoided, preventing a situation where only some of the storage segments directly relating to the command are read from or written to. In some embodiments, a lock is obtained only on storage segments directly relating to the command, i.e. segments which are read from, written to or otherwise subject to (i.e. referred to by) the command. In other embodiments a lock may be obtained on storage segments relating directly or indirectly to the command. For example storage segments which are indirectly related to the command (i.e. segments which are not read from, written to, or otherwise subject to (i.e. referred to by) the command) may in some cases also need to be locked to ensure correctness of the command, for meta data, and/or for any other reason (see for example description of FIG. 6 below). Continuing with the example, indirectly related storage segments may in some cases be used synchronously in the processing of the command. Unless explicitly stated otherwise, the term “relating to a command” and variants thereof should be understood to refer to embodiments where the storage segments are directly related and to embodiments where the storage segments are directly or indirectly related.

In the illustrated embodiments of method 200, a predetermined order is followed when attempting to obtain a lock on storage segments in storage 150 for any input/output command. Therefore, the same command sequence is preserved across segments. For example, assume both commands A and B attempt to obtain a lock, exclusive of the other, on segments C and D. The same command sequence would be preserved for segments C and D if command A and B both follow the same predetermined order, for instance with command A attempting to obtain the lock on segment C prior to segment D, and command B also attempting to obtain the lock on segment C prior to segment D. However, assume in the same example that a predetermined order is not followed when attempting to obtain a lock. Therefore command A attempts to obtain a lock on segment C prior to command B and succeeds, but command B attempts to obtain a lock on segment D prior to command A and succeeds. In the latter case where the predetermined order was not followed, there would be a higher likelihood of deadlock where neither command could be performed because command B would be waiting for command A to unlock segment C while command A would be waiting for command B to unlock segment D.

In some embodiments, the predetermined order comprises ascending or descending addresses of the storage segments. In an embodiment where the predetermined order follows ascending addresses, a storage segment with a lower address is locked before a storage segment with a higher address. In an embodiment where the predetermined order follows descending addresses, a storage segment with a higher address is locked before a storage segment with a lower address. However the invention is not bound by a specific predetermined order and in various embodiments any appropriate predetermined order may be defined, as long as the predetermined order is followed by all commands.

In the illustrated embodiments of stage 204, controller 120 receives an I/O command, which was generated by I/O command generator 104. The I/O command relates to k storage segments (directly or indirectly) in storage 150, where 1≦k≦n. (As was mentioned above the total number of storage segments in storage 150 is assumed to equal n).

In one embodiment, one or more dynamic elements may be created in stage 204, for example one or more controllers assigned to a subset including the received command may be created, if not already existing. In another embodiment, dynamic elements may not be created at this stage.

In some embodiments, the module of controller 120 which receives the command is command executor 128.

Depending on the embodiment, the k storage segments relating to the received command may or may not be contiguous in storage 150. In one embodiment, all k storage segments may be contiguous. In another embodiment, none of the k storage segments may be contiguous. In yet another embodiment, some of the k storage segments may be contiguous with one another.

Starting with the first storage segment of the k storage segments related to the received JO command according to the predetermined order (stage 206), controller 120 attempts to lock the storage segment for the received I/O command in the illustrated embodiments of stage 208. In some embodiments, the module of controller 120 which attempts to lock the storage segment is locker/unlocker module 124.

The locking attempt is not limited by the invention, but for the sake of further guidance for the reader, a few embodiments are now presented.

In some embodiments, stage 208 may include locking the properties of the storage segment. For example, if the storage segment is a block, the block properties may be locked. Once the properties are locked, the data lock status of the storage segment may be checked. For example, the data lock status may have been set to “read” or variants thereof by a previous I/O command if the previous command will not change the content of the block or to “write” or variant thereof if the previous command will change the content of the block. In this example, if the data lock status is not currently set to “read” or “write” or variants thereof, the storage segment is not locked. In another example, the data lock status may have been set to “locked” or variants thereof by a previous I/O command, rather than to “read” or “write” or variants thereof, for instance in the case that the characteristics of the lock are similar regardless of whether the command changes the content of the block or not. In this example, if the data lock status is not currently set to “locked” or variants thereof, the storage segment is not locked. In some cases, when the segment is not locked, the data lock status may be set to “free”, “unlocked”, or any other appropriate indicator, whereas in other cases, the data lock status may not be indicated when unlocked.

In some embodiments, a dynamic element or elements (such as controller, queue, pointer, tree node, and/or counter) exist/s for a storage segment when the storage segment is locked for command(s), and/or when command(s) is/are waiting to lock the storage segment. In these embodiments, if a dynamic element does not exist, then the storage segment is not locked. Therefore, in one of these embodiments, stage 208 may additionally or alternatively include checking whether a dynamic element does not exist, meaning that the storage segment is not locked. It should be noted that in some cases a dynamic element such as a controller, queue, pointer, tree node and/or counter may be created and/or discarded with reference to another event (for example with reference to receipt and/or performance of command(s)). It should also be noted that controllers, queues, pointers tree nodes, and/or counters are not necessarily dynamic. Therefore in some embodiments, the non-existence of controller(s), queue(s), pointer(s) and/or counter(s) does not necessarily provide an accurate indication that the storage segment is not locked.

In some embodiments where the storage segment is found to be locked, stage 208 may additionally or alternatively include checking whether the current lock is non-exclusive or exclusive, (i.e. checking whether the sharing policy allows or forbids the received command to share the lock). In these embodiments, if under the sharing policy the received command can share the lock, then there is no ban on overlapping access to the storage segment by the received command and other command(s) already holding the lock. Depending on the embodiment, the sharing policy may be the same for all storage segments in storage 150 or may in some cases be different for different storage segments. Depending on the embodiment, the sharing policy may be dynamic, automatically varying for example with time or due to other factors, the sharing policy may remain the same once initially established, or the sharing policy may remain the same unless updated (for example through user intervention).

The sharing policy is not limited by the invention but for further illustration to the reader some examples will now be presented. For example, in one embodiment the sharing policy for a storage segment may dictate that sharing is never allowed and therefore a lock is always exclusive, forbidding overlapping access to the storage segment. In this example, the received command cannot share the lock. Therefore in this example, prioritization of commands follows a first in first out rule. In another example, in one embodiment the sharing policy for a storage segment may dictate that a lock is never exclusive and that sharing the lock is always allowed with no ban on overlapping access to the storage segment. In this example, the received command can share the lock.

In another example, the sharing policy may dictate that a plurality of read commands or other I/O commands which do not change the content of the storage segment can share a lock with no ban on overlapping access. In this example, however the sharing policy may dictate that no other command can share a lock with a write command or other command which changes the content of the storage segment, thereby making the lock exclusive and banning overlapping access to the storage segment in this latter case. Therefore in this example, the received command can share the lock with previous command(s) (meaning the lock may be non-exclusive with no ban on overlapping access) only if the received command and the command(s) holding the lock are read commands or other command(s) which do not change the content of the storage segment. Continuing with the example, and assuming that the data lock status can be differentiated as “read” or “write” (or variants thereof), in one embodiment sharing will be allowed if the received command is a read command/other command that does not change the content of the storage segment and the data lock status is “read” or variants thereof. Continuing with the example, and assuming that one or more dynamic elements (for example a controller, queue, pointer, tree node, counter) only exist(s) if the command(s) holding the lock is/are read command(s) or other command(s) that do/does not change the content of the storage segment, in one embodiment sharing will only be allowed if the dynamic element(s) exist(s) and the received command is a read command/other command that does not change the content. In this example, a received read commands/other non-content changing command may have enhanced priority over a waiting write commands/other content-changing commands due to the sharing policy.

In another example, the sharing policy may dictate that a plurality of read commands or other I/O commands which do not change the content of the storage segment can share a lock with no ban on overlapping access provided the number of waiting write commands (or other commands which change the content of the storage segment) is below a predetermined ceiling. However in this example no other command can share a lock with a write command or other command which changes the content of the storage segment. Continuing with the example, assume that the data lock status can be differentiated as “read” or “write” or variants thereof (and/or particular dynamic element(s) only exist(s) when the lock can be shared with the command(s) currently holding the lock). Assume also that the number of waiting write commands (or other commands which change the content of the storage segment) is known. Under these assumptions, in one embodiment of this example, sharing will be allowed (meaning the lock will be non-exclusive with no ban on overlapping access) only if the received command is a read command/other non-content changing command, the data lock status is “read” or variants thereof (and/or the dynamic element(s) indicating that the lock can be shared exist(s)), and the number of waiting write/other content changing commands is less than the predetermined ceiling. Depending on the embodiment, the predetermined ceiling can be any number equal to or greater than one. In one embodiment, assuming the ceiling is set to one, lock sharing will not be allowed if there a waiting write/content changing command, and therefore the waiting time for accessing a storage segment by a waiting write/content changing command will not be extended due to lock sharing. It is noted that depending on the embodiment, lock sharing can increase the waiting time due to overlapping access and/or non-overlapping access by commands sharing the lock. In one embodiment, the relative prioritization of waiting write/content changing commands versus received read/non-content changing commands may be increased by lowering the value of the ceiling, or decreased by increasing the value of the ceiling.

In another example, the sharing policy may dictate that a plurality of read commands or other I/O commands which do not change the content of the storage segment can share a lock with no ban on overlapping access provided the longest wait time of waiting write commands (or other commands which change the content of the storage segment) is below a predetermined ceiling. However in this example no other command can share a lock with a write command or other command which changes the content of the storage segment. Continuing with the example, assume that the data lock status can be differentiated as “read” or “write” or variants thereof (and/or particular dynamic element(s) only exist(s) when the lock can be shared with the command(s) currently holding the lock). Assume also that the wait times of waiting write commands (or other commands which change the content of the storage segment) are known. Under these assumptions in one embodiment of this example, sharing will be allowed (meaning the lock will be non-exclusive with no ban on overlapping access) only if the received command is a read command/other non-content changing command, the data lock status is “read” or variants thereof (and/or the dynamic element(s) indicating that the lock can be shared exist(s)), and the longest wait time of waiting write/other content changing commands is less than the predetermined ceiling. Depending on the embodiment, the predetermined ceiling can be any amount of time. In one embodiment, the relative prioritization of waiting write/content changing commands versus received read/non-content changing commands may be increased by lowering the value of the ceiling, or decreased by increasing the value of the ceiling.

In another example, the sharing policy may comprise a plurality of conditions. Continuing with the example, in some cases the sharing policy may dictate that a plurality of read commands or other I/O commands which do not change the content of the storage segment can share a lock with no ban on overlapping access provided the longest wait time of waiting write commands (or other commands which change the content of the storage segment) is below a first predetermined ceiling and the number of waiting write/other content changing commands is less than a second predetermined ceiling. However in this example no other command can share a lock with a write command or other command which changes the content of the storage segment. Continuing with the example, assume that the data lock status can be differentiated as “read” or “write” or variants thereof (and/or particular dynamic element(s) only exist(s) when the lock can be shared with the command(s) currently holding the lock). Assume also that the number and wait times of waiting write commands (or other commands which change the content of the storage segment) are known. Under these assumptions, in one embodiment of this example, sharing will be allowed (meaning the lock will be non-exclusive with no ban on overlapping access) only if the received command is a read command/other non-content changing command, the data lock status is “read” or variants thereof (and/or the dynamic element(s) indicating that the lock can be shared exist(s)), the longest wait time of waiting write/other content changing commands is less than the first predetermined ceiling and the number of waiting write/other content changing commands is less than the second predetermined ceiling.

In another example, the sharing policy may dictate that a limited number of read commands or other I/O commands which do not change the content of the storage segment can share a lock. Continuing with the example, in some cases the sharing policy may allow up to a maximum number of read commands/other non-content changing commands to share the lock, with overlapping or non-overlapping access. The value of the maximum is not limited by the invention. In one embodiment of this example, the relative prioritization of waiting write/content changing commands versus received read/non-content changing commands may be increased by lowering the value of the maximum, or decreased by increasing the value of the maximum.

Although as mentioned above, the sharing policy is not limited by the invention, in some embodiments, the sharing policy may de facto be constrained by a worse case scenario where a write/other content changing command would wait too long or indefinitely. For example, in one of these embodiments, the predetermined ceiling on waiting write/other content changing commands may be limited to one, in order to avoid a worse case scenario where the ceiling is two or higher, but because only one write command is received among many read commands, the write command is forced to wait too long (until the next write command is received) or indefinitely.

If after executing stage 208, controller 120 knows that the storage segment is not already locked (“no” at decision block 212), then in the illustrated embodiments of stage 240, controller 120, obtains a lock on the storage segment.

For example, in one embodiment, controller 120 may obtain a lock on the storage segment by setting the data lock status of the storage segment to “write” or “read” (or variants thereof) depending on whether or not the command will change the content of the storage segment, or more simply to “locked” or variants thereof.

In another example, additionally or alternatively, controller 120 may create in some embodiments a dynamic element or elements such as controller, queue, counter, tree node and/or pointer to indicate that the storage segment is locked. Continuing with the example, in some of these embodiments, controller 120 may additionally or alternatively create one or more dynamic element(s) only if the command holding the lock can share the lock at least in some cases in accordance with the sharing policy. For instance, in one of these embodiments, if the received command is a read command or other command that does not change the content of the storage segment, controller 120 may create one or more dynamic elements to indicate that the storage segment is locked and additionally one or more dynamic elements to indicate that the command holding the lock is a read command/other command that does not change the content. However in this embodiment, if the received command is a write command or other command that does change the content of the storage segment, controller 120 may create the one or more dynamic elements to indicate that the storage segment is locked (but not the additional dynamic element(s) which would have been created for a read command/other command that does not change the content).

If the storage segment properties were locked in stage 208, then in some cases the storage segment properties can be released after performing stage 240.

In some embodiments, the module of controller 120 which performs stage 240 is locker/unlocker module 124.

It is possible instead, after executing stage 208, that controller 120 knows that the storage segment is currently locked (“yes” at decision block 212) and that the received command is allowed to share the lock (“yes” at decision block 220). Therefore, in the illustrated embodiments of stage 224, controller 120 obtains a lock on the storage segment. Since the lock is shared with at least one other command which obtained the lock earlier, in one embodiment it is assumed that the data lock status of the storage segment already specifies that the storage segment is locked and/or that any dynamic elements which exist when the storage segment is locked (and/or when the lock can be shared) already exist. In one embodiment, in stage 224, controller 120, indicates that the lock is being held by an additional command, namely the command received in stage 204. Assuming the storage segment properties were locked in stage 208, then in some cases controller 120 releases the storage segment properties at the end of stage 224. In some embodiments, the module of controller 120 which performs stage 224 is locker/unlocker module 124.

If instead, there is a “yes” at decision block 212 and a “no” at decision block 220, meaning that the received command is not allowed to obtain even a shared lock on the storage segment, then in the illustrated embodiments of stage 228, controller 120 sets the received command to wait for “wakeup”. Wake up occurs when the received command is no longer required to wait to obtain a lock on the storage segment but is allowed to obtain a lock on the storage segment. Assuming the storage segment properties were locked in stage 208, then in some cases controller 120 releases the storage segment properties sometime during stage 228. In some embodiments, the module of controller 120 which performs stage 228 is locker/unlocker module 124.

The invention does not place a limitation on how it is determined that the waiting received command can obtain a lock on the storage segment and can therefore be woken up (“wake up policy”). However for the sake of illustration to the reader, some examples of wakeup policies are now presented. For example, in one embodiment, command wakeup follows a first in first out prioritization rule. Therefore in this embodiment once a storage segment has been unlocked, the waiting command that is woken up to obtain the lock on the storage segment is the one which unsuccessfully requested the lock and was set for wakeup prior to all the other waiting commands waiting for wakeup (i.e. the command which is woken up is the waiting command which has waited the longest among all the waiting commands). As another example, in one embodiment, write commands or other content changing commands are prioritized over read commands or other non-content changing commands. Continuing with the example, once a storage segment has been unlocked, in some cases a waiting write command may be woken up to obtain the lock even though waiting read command(s) were set for wakeup before the write command. As another example, prioritization may be additionally or alternatively based on the command generator 104, where commands issued by a particular generator are prioritized over commands issued by another generator. Therefore the wakeup will try to advance commands sent by the particular generator over commands sent by the other generator. This prioritization scheme may in some cases be combined with any other prioritization scheme.

In one example, a waiting command is woken up once a storage segment has been unlocked. In another example, a waiting command may additionally or alternatively be woken up if it becomes possible for the waiting command to share the lock under the sharing policy. In one embodiment of this example, after a previously locked storage segment has been unlocked, a waiting command is woken up to obtain a lock on the storage segment and any other waiting commands which can share the lock under the sharing policy are also woken up and obtain (share) the lock. In this embodiment, the prioritization of waiting commands which can share the lock with the woken up command is increased over other waiting commands which cannot share the lock.

Depending on the embodiment, the wakeup policy may be the same for all storage segments in storage 150 or may in some cases be different for different storage segments. Depending on the embodiment, the wakeup policy may be dynamic, automatically varying for example with time or due to other factors, the wakeup policy may remain the same once initially established, or the wakeup policy may remain the same unless updated (for example through user intervention).

Although as mentioned above, the wakeup policy is not limited by the invention, in some embodiments, the wakeup policy may de facto be constrained by a worse case scenario where a waiting command would wait too long or indefinitely. For example, in one of these embodiments, command wakeup follows a first in first out prioritization rule in order to avoid a worse case scenario where a command is forced to wait too long or indefinitely.

Once the received command is woken up (“yes” at decision block 232), controller 120 proceeds to obtain a lock on the storage segment for the received command in the illustrated embodiments of stage 236.

For example, in one embodiment, controller 120 may first lock the properties of the storage segment. In this embodiment, controller 120 may then obtain a lock on the storage segment by setting the data lock status of the storage segment to “write” or “read” or variants thereof, depending on whether or not the command will change the content of the storage segment, or more simply to “locked” or variants thereof. Controller 120 may then release the properties of the storage segment.

In another example, additionally or alternatively, controller 120 may create in some embodiments a dynamic element or elements if the command now holding the lock can share the lock at least in some cases in accordance with the sharing policy. For instance, in one of these embodiments, if the (woken up) received command is a read command or other command that does not change the content of the storage segment, controller 120 may create one or more dynamic elements to indicate that the command holding the lock is a read command/other command that does not change the content. However in this embodiment, if the received command is a write command or other command that does change the content of the storage segment, controller 120 would not create the dynamic element(s).

In some embodiments, the module of controller 120 which performs stage 236 is locker/unlocker module 124.

In some embodiments, a command can in some cases be woken up to obtain a lock which will be shared with one or more other commands that have already obtained the lock. In one of these embodiments, if the received command is woken up to share the lock, method 200 proceeds to stage 224 after a “yes” at decision block 232 instead of to stage 236.

Once a lock has been obtained on the storage segment in stage 224, 236 or 240, and if there are remaining storage segments out of the k storage segments (“no” at decision block 244), then for the next storage segment according to the predetermined order (stage 248) method 200 iterates back to stage 208.

Once locks have been obtained on all of the k storage segments relating to the received command (“yes” at decision block 244), the received command is performed by controller 120 in the illustrated embodiments of stage 252. The performance of the received I/O command in stage 252 is not limited by the invention, and since procedures for performing commands are known in the art, no further details will be provided here. In some embodiments, the module of controller 120 which performs stage 252 is command executor 128.

Because locks on all k storage segments relating to the received command are obtained for the command prior to performing the command, the command can be fully performed. The command will not be hindered for instance by overlapping access of other commands to storage 150. For example, if there is overlapping access to storage 150 with another command which relates to storage segments other than the k storage segments, the overlapping access to storage 150 will not interfere with command execution. As another example, if another command relates to common segment(s) from the k segments (where the number of common segments may range from 1 to k), then in some cases the received command and the other command may share access according to the sharing policy. Continuing with the example, assume instead that the received command and the other command cannot share access according to the sharing policy. Because the received command and the other command would both proceed in the predetermined order to lock segments, one of the commands would obtain the lock on common segment(s) and the second command would be set to wait for the lock in accordance with the wakeup policy, thereby not interfering with one another.

In some embodiments, a lock on one or more of the k segments may have been effectively obtained through the lock(s) on other segment(s). Continuing with the example, if a second segment can not be accessed without first accessing a first segment, then locking the first segment may in some cases effectively lock the second segment. In these cases, the second segment would not need to be independently locked to ensure that a command will fully execute without hindrance.

In one embodiment with dynamic controller(s) associated with command subsets, a dynamic controller responsible for the performed command may be discarded after stage 252 if the performed command is the last command to be performed from the subset.

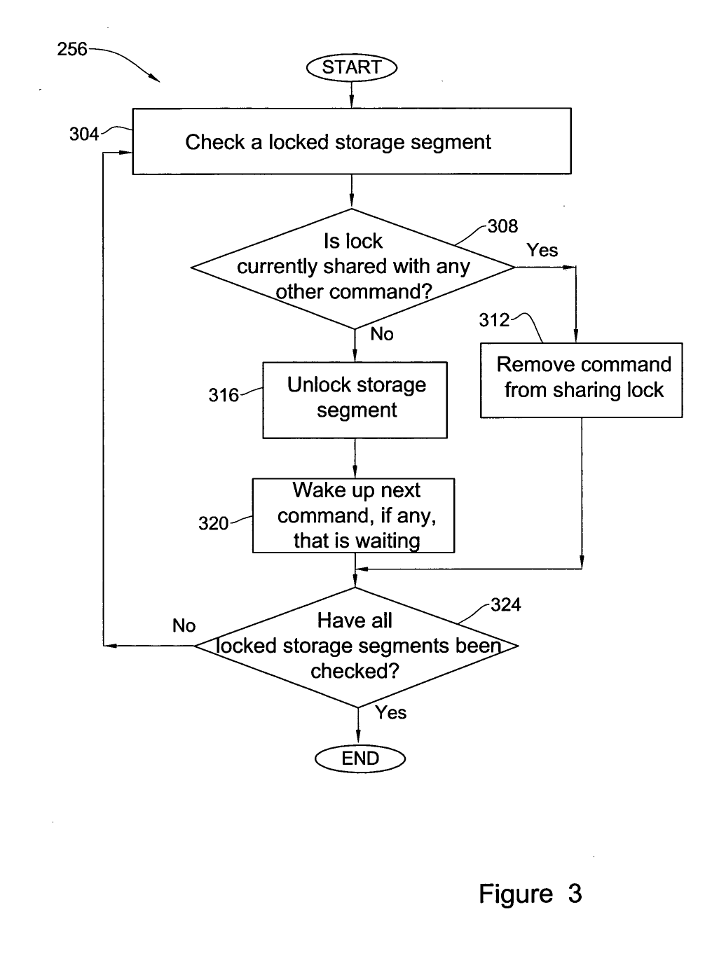

In the illustrated embodiments of stage 256, controller 120 unlocks any of the k storage segments which are not currently shared with other commands. More details on the unlocking are provided in method 300 with reference to FIG. 3. In some embodiments, the module of controller 120 which performs stage 256 is locker/unlocker module 124.

In one embodiment, all of the k storage segments which are not currently shared with other commands are unlocked after the entire command has executed. In another embodiment, one or more of the k storage segments which are not currently shared with other commands may be unlocked prior to the completion of command execution. For example in some cases in the latter embodiment, a storage segment whose lock is not shared may be unlocked during command execution if the storage segment is no longer required for the remaining command execution.

Method 200 then ends.

FIG. 3 is a flowchart illustration of an unlocking method corresponding to stage 256 of method 200, according to some embodiments of the invention.

In some cases, the unlocking method may include fewer, more and/or different stages than illustrated in FIG. 3, the stages may be executed in a different order than shown in FIG. 3, and/or stages that are illustrated as being executed sequentially may be executed in parallel. For example, for ease of illustration, one storage segment at a time is shown processed in FIG. 3. However, it is not required that each storage segment is processed separately. In some embodiments, a plurality of storage segments may be processed in parallel in stage 256, and in one of these embodiments all k segments relating to the I/O command are processed in parallel.

In embodiments where not all k storage segments are processed in parallel, the sequence of processing storage segments in stage 256 is not limited by the invention. In one of these embodiments, the k storage segments are processed in the same predetermined order previously used in attempting to lock the k storage segments for the I/O command. In another of these embodiments, additionally or alternatively, each of the k storage segments is processed when no longer needed for remaining command execution. In other embodiments, other sequences are used. Typically although not necessarily, the sequence used will not deprive waiting commands from timely access to the storage segments.

In embodiments where the k storage segments are divided into a plurality of groups and segments in each group are processed in parallel, the invention does not place a limitation on which segments are grouped together, or on the number of segments grouped together. In one of these embodiments, storage segments that are next to one another in accordance with the predetermined order previously used in locking the storage segments are grouped together. Assuming separate individual controllers or pluralities of controllers are responsible for different assigned storage segment subsets, in one of these embodiments segments belonging to different subsets may be grouped together and processed in parallel. In one of these embodiments, storage segments that stop being needed for remaining command execution around the same time are grouped together. However in other embodiments, other groupings may be used.

In the illustrated embodiments of stage 304, it is checked whether or not a locked storage segment can be unlocked. In some cases, the properties of the storage segment may be locked prior to checking.

In some embodiments, it is assumed that a storage segment relating to the I/O command received in stage 204 (FIG. 2) can be unlocked after the command has been performed in stage 252 (FIG. 2) as long as no other command is sharing the lock. Depending on the embodiment, the access to the storage segment by other commands sharing the lock with the performed command may overlap with the access by the performed command or may not overlap. In either case of overlapping access or non-overlapping access, other command(s) may still be holding the lock. Therefore, in these embodiments it is determined whether or not any other command is sharing the lock. Assuming that each time a command joins to share a lock on a storage segment (in stage 224 of FIG. 2), it is indicated and each time a command stops sharing a lock on a storage segment (stage 312) it is indicated, then based on these indications it can be determined whether or not any other command is sharing the lock.

In the illustrated embodiments, if the lock is not currently shared with any other command (“no” at decision block 308), then in stage 316 the locked storage segment is unlocked. For example, in one embodiment the data lock status is set to “Free”, “unlocked” or variants thereof, or simply not indicated, signifying that the storage segment is not locked. As another example, in one embodiment, additionally or alternatively, any dynamic elements which are no longer needed may be discarded. Continuing with the example, in some cases dynamic element(s) which indicate that the lock could be shared at least in some cases under the sharing policy, may be discarded. As another example, additionally or alternatively, if there are no waiting commands, then in some cases dynamic elements which indicate that the storage segment is locked and/or that one or more commands are waiting may be discarded. As another example, additionally or alternatively, assuming dynamic controllers whose existence relates to locked segments and/or waiting commands, if there are no waiting commands and the storage segment was the final locked segment in the subset for which a controller is responsible, the controller may be discarded.

In the illustrated embodiment of stage 320, if there are command(s) waiting to obtain the lock, one or more of the waiting commands are woken up to obtain the lock, in accordance with the wakeup policy. The wakeup policy is not limited by the invention, but for further illustration the reader is referred to some embodiments which were presented above with reference to FIG. 2.

In one embodiment, if there are commands waiting to obtain the lock, the properties of the storage segment are only released after the waiting command(s) is/are woken up to obtain the lock. This embodiment may in some cases prevent a scenario where the properties of the storage segment are locked for a newly arriving I/O command and it is verified that the data lock status is not locked in the time interval between stages 316 and 320, thereby allowing the obtaining of the lock for the newly arriving I/O command before the waiting command(s). In other embodiments, the limitation on the timing of the releasing of the properties may in some cases be relaxed, for example in some cases if sharing with the waiting command(s) is allowed, or for example in some cases when the determination of whether or not a lock can be obtained for the newly arriving command relies additionally or alternatively on dynamic element(s).

In the illustrated embodiments, if instead the lock is currently shared with any other command (“yes” at decision block 308), then the locked storage segment is not unlocked. Instead, in the illustrated embodiments of stage 312 the command (which was previously performed in stage 252, FIG. 2) is removed from sharing the lock. For example, there may be an indication that one less command is now sharing the lock.

In the illustrated embodiments, if there are any more locked segments, out of the k storage segments related to the command, that need to be checked (“no” at decision block 324) the method iterates to stage 304 in order to check another segment.

In the illustrated embodiments, once all k storage segments have been checked (“yes” at decision block 324), the method ends.

Assuming embodiments where a segment was effectively locked through the lock on another segment, then in one embodiment the segment which was effectively locked through the lock on another segment may be effectively unlocked through the unlocking of the other segment, and would not need to be independently unlocked.

Assuming embodiments where the sharing policy does not allow sharing, then in one of these embodiments, stages 304 to 312 are omitted, meaning that stages 316 to 320 are performed for each of the k segments.

FIG. 4 is a more detailed block diagram of a system 400 for generating and managing input/output commands, according to some embodiments of the invention. System 400 is an example of system 100.

In the illustrated embodiments of system 400, locker/unlocker module 124 comprises a locator module 432 configured at least to locate queues and/or counters associated with storage segments, a counter manager 436 configured at least to implement the sharing policy, and a queue and/or pointer manager module 440 configured inter-alia to implement the wakeup policy. In some embodiments, locker/unlocker module 124 may comprise fewer, more, and/or different modules than illustrated in FIG. 4. In some embodiments, locker/unlocker module 124 may include additional or less functionality than described herein. In some embodiments, the functionality of locator module 432, counter manager 436 and queue and/or pointer manager 440 described herein below may be divided into fewer, more and/or different modules. In some embodiments of the invention, locator module 432, counter manager 436, and/or queue and/or pointer manager 440 may have more, less and/or different functionality than described herein, and/or the functionality described herein may be divided differently among modules 432, 436 and 440.

For example, in one embodiment, locker/unlocker module 124 may additionally or alternatively comprise one or more separate modules configured to lock and unlock the properties and/or the data lock status of various storage segments. As another example, in other embodiments, this functionality may be provided by any of modules 432, 436 and/or 440, or this functionality may be omitted.

As another example, in one embodiment, the sharing policy may not allow sharing a lock, or counters may not be used for sharing a lock, and therefore counter manager 436 may be omitted.

As another example, in some embodiments, queue and/or pointer manager 440 may be divided into two modules, such as “queue manager” responsible for queues and “pointer manager” responsible for pointers. In one of these embodiments, for instance, the functionality of pointer management may be omitted if queues and counters are not pointed to by pointers.

As another example, in one embodiment, the functionality of queues management in queue and/or pointer manager 440 may be omitted if the waiting policy does not allow commands to wait for wakeup, or if waiting commands wait for wakeup without using queues.

As another example, in one embodiment, the functionality of counter, queue and pointer management may be provided by one module and not divided into two modules (436 and 440).

In some embodiments, queue and/or pointer manager 440 comprises one or more controllers. For example, in some of these embodiments, there may be separate controllers for different subsets of storage segments (where each subset includes at least one storage segment). In one of these embodiments, a particular controller responsible for a storage segment subset may be created when first a lock is to be obtained on a storage segment in the subset, and discarded when all segment(s) in the subset is/are unlocked and all queue(s) relating to the segment(s) is/are empty (i.e. no commands waiting for wakeup). Alternatively, in some of these embodiments, the existence of the controller(s) may be unrelated to whether or not storage segments are locked.

In some embodiments, counter manager 436 comprises one or more controllers. For example, in some of these embodiments, there may be separate controllers for different subsets of storage segments (where each subset includes at least one storage segment). In one of these embodiments, a particular controller responsible for a storage segment subset may be created when first a storage segment for which the particular controller is responsible is to be locked with a lock which at least in some cases may be shared under the sharing policy. In this embodiment, a particular controller responsible for a storage segment subset may be discarded when there are no longer locked segments for which the particular controller is responsible, whose lock can be shared at least in some cases under the sharing policy. In another of these embodiments, for example, a particular controller responsible for a storage segment subset may be created when first a lock is to be obtained on a storage segment in the subset, and discarded when all segment(s) in the subset is/are unlocked and all queue(s) relating to the segment(s) is/are empty (i.e. no commands waiting for wakeup). Alternatively, in some of these embodiments, the existence of the controller(s) may be unrelated to whether or not storage segments are locked.

In some embodiments, counter manager 436 comprises separate controllers for different storage segment subsets and queue and/or pointer manager 440 comprises separate controllers for different storage segment subsets. In one of these embodiments the counter manager controller and the queue and/or pointer manager controller may be combined for each segment subset.

In the illustrated embodiments, pointers 460, queues 462 and counters 470 are associated with storage segments. In the illustrated embodiments, pointers 460, queues 462 and counters 470 are located in storage 150. In some cases, pointers 460, queues 462 and/or counters 470 are examples of information stored in storage 150 relating to controller operation. However in some embodiments, pointers 460, queues 462 and counters 470 may be located elsewhere. For example, in one of these embodiments, pointers 460, queues 462 and/or counters 470 may be located in controller 120.

In the illustrated embodiments of system 400, if a received I/O command cannot immediately obtain a lock on a storage segment 154, the command waits in a queue 462 associated with the storage segment. Depending on the embodiment, the command may be set to wait in the queue in any appropriate way. For example, in various embodiments, command associated element(s) such as command particulars (e.g. SCSI I/O command), a pointer to command particulars, a unique identifier, a structure holding command particulars, etc may be set in the queue. As another example, additionally or alternatively, controller associated element(s) such as an identifier of or a pointer to a controller which is responsible for the command may be set in the queue.

In some embodiments, queue and/or pointer manager 440 manages the queue 462 in accordance with the wakeup policy of system 400. Some examples of wakeup policies were described above with reference to FIG. 2.

As mentioned above, in some cases commands share a lock on a storage segment. In the illustrated embodiments of system 400, counter manager 436 manages a counter 470 associated with the storage segment, for example in accordance with the sharing policy of system 400. Some examples of sharing policies were described above with reference to FIG. 2.

Depending on the embodiment, a pointer 460 associated with a storage segment may always exist in system 400 (i.e. may be static), or a pointer may be dynamic. For example, in some cases with static pointers 460, there may be n pointers 460, i.e. one for each storage segment 154. In an embodiment where pointers are not used, pointers 460 may be omitted. In the illustrated embodiments, it is assumed that pointers 460 are dynamic and that the number of pointers 460 can be less than or equal to n. For example, in one embodiment, a pointer is generated with the first lock request for the segment and is removed once there are no longer commands holding or waiting for a lock on that segment.

Depending on the embodiment, a queue 462 associated with a storage segment may always exist in system 400 (i.e. may be static), or a queue may be dynamic. For example, in some cases with static queues 462, there may be n queues 462, i.e. one for each storage segment 154. In an embodiment where waiting is not allowed or waiting is not in queues, queues 462 may be omitted. In the illustrated embodiments, it is assumed that queues 462 are dynamic and that the number of queues 462 can be less than or equal to n. For example, in one embodiment, a queue is generated with the first lock request for the segment and is removed once there are no longer commands holding or waiting for a lock on that segment.

Depending on the embodiment and assuming sharing a lock is sometimes allowed according to the sharing policy, a counter 470 associated with a storage segment may always exist in system 400 (i.e. may be static), or counters 470 may be dynamic. For example, in some cases with static counters 470, there may be n counters 470, i.e. one for each storage segment 154. In an embodiment where sharing is not allowed or does not use counters, counters 470 may be omitted. In the illustrated embodiments, it is assumed that counters 470 are dynamic and that the number of counters 470 can be less than or equal to n.

In the illustrated embodiments of FIG. 4, more storage segments are associated with queues 462 than are associated with counters 470. These embodiments assume that fewer counters 470 than queues 462 are dynamically created for storage segments. For example, in some cases queues 462 are created for all locked storage segments whereas counters 470 are only created for locked storage segments where sharing is at least sometimes allowed according to the sharing policy. Continuing with the example, assuming that there is at least one locked storage segment for which sharing is not allowed, there will be fewer counters 470 created than queues 462. However, in other embodiments there may be the same number of queues 462 as counters 470. For example there may be the same number of queues 462 as counters 470, if the same number of counters 470 and queues 462 are dynamically created for storage segments, or if the same number of static queues 462 and counters 470 exist.

In some embodiments, locator module 432 comprises one or more controllers. For example, in one of these embodiments, there may be separate controllers for different command subsets (where each subset includes at least one command). In one of these embodiments, a particular controller responsible for a command subset may be created when first a command for which the particular controller is responsible is received. In this embodiment, a particular controller responsible for a command subset may be discarded when all commands for which the particular controller is responsible have been performed. Alternatively, in some of these embodiments, the existence of the controller(s) may be unrelated to whether or not command(s) in the command subset have been received and/or performed.

In the illustrated embodiments, locator module 432 includes one or more hash generators, configured to generate one or more hash functions. In some embodiments, each hash generator implements a hash function and is operative on a set of predefined storage segments. In some of these embodiments, all of the one or more hash generators implement the same hash function. In other embodiments, a plurality of hash generators is divided into subgroups, each with a unique hash function.

In some embodiments, double (or even several) layer hashing can be implemented in order to deal with a plurality of segments mapping to the same entry.

In some embodiments, locator 432 applies another n to m mapping function (where n is the number of segments and m is the number of entries) and/or search utility which enables locating the queue and/or counter associated with a storage segment, in addition to or instead of the hash function. In one of these embodiments, any search tree, for example a binary search tree, a balanced binary search tree, another type of balance search tree, etc. can be used. In this embodiment each node in the tree, for example holds a pointer to a storage segment. Search, insertion and deletion of nodes are known operations for a person skilled in the art.

In the illustrated embodiments, locator 432 implements a hash function and there is a hash table 458 which includes m entries. The invention does not restrict the number m and m can be any number, greater than, smaller than or equal to n (where n is the number of storage segments). However in one embodiment, m is selected by estimating the number of storage segments that will be accessed at a given time. In this embodiment, the estimate for m is usually less than n. The entries in the hash table indicate the location of queues and/or counters, for example by holding pointers which point to queues and/or counters. Herein below for simplicity of explanation it is assumed that the entries hold pointers. At any point in time, each entry can hold zero or more pointers. In the illustrated embodiments, each pointer in an entry is uniquely associated with a storage segment. It is noted that in the illustrated embodiments, locator 432 maps a storage segment to an entry in hash table 458 via a hash function which is not necessarily 1:1. Therefore in these embodiments, two or more storage segments may in some cases map to the same entry. Referring to the example of hash table 458 in FIG. 4, the first, second, and m^{th} entry include one pointer 460 each, the third entry includes no pointers, and the fourth entry includes two pointers 460. In other embodiments, the hash function may be required to be 1:1.

It is also noted that in the illustrated embodiments, pointer₅₅ 460 (associated with storage segment₅₅) is located in a lower entry (H₁) of hash table 458 than pointer₇ 460 which is located in a higher entry of the hash table (H₄). In these embodiments, therefore, locator 432 does not necessarily preserve the sequence of the storage segments when mapping storage segments to entries in hash table 458, although in some cases the sequence may be preserved across some or all entries. In other embodiments, locator 432 does necessarily preserve the sequence of the storage segments when mapping storage segments to entries in hash table 458.

In the illustrated embodiments, hash table 458 and pointers 460 in entries of hash table 458 are shown located in storage 150. In some cases, hash table 458 and/or pointers 460 are examples of information stored in storage 150 relating to controller operation. In other embodiments, hash table 458 and/or pointers 460 may be located elsewhere, for example in controller 120. In other embodiments, hash table 458 and/or pointers 460 in the entries may be omitted, for example if queues 462 and/or counters 470 are not accessed through hash table 458.

In embodiments where a (balanced) search tree is used, each node replaces the functionality of an entry in the hash table. The behavior of each node and content thereof will depend on the type of search tree chosen. For example, in the case of a (balanced) Binary Search Tree (BST), each node of the search tree may in some cases pertain to only one storage segment and therefore will indicate (at most) the location of a single queue and a single counter. The nodes in the tree indicate the location of queues and/or counters, for example by holding pointers which point to queues and/or counters. Herein below for simplicity of explanation it is assumed that the nodes hold pointers. The tree is managed by holding in the node the identifier of the storage segment with which the node is associated. When storage segment X is being accessed, locator 432 searches from the top node of the tree for the identifier of segment X. If the identifier of segment X is smaller than the identifier in the top node, locator 432 searches the subtree on the left hand side, and if greater then on the right hand side. If a node was previously allocated which holds the identifier of X then locator 432 will access the pointer associated with segment X and held by the node, and thereby access the queue and counter (if any) associated with segment X. If no node holds the segment identifier and locator 432 has reached the leaf of the tree then an extension node to the tree will be generated at the leaf either to the left or to the right, depending on whether the identifier of segment X is smaller or larger than the segment identifier in the leaf. Once created the extension node will be used as the access point to said storage segment, for example via the pointer held by the extension node. Once a node is no longer needed, for example when no commands are holding or waiting for a lock on the corresponding storage segment, the node can be removed and the tree if necessary adjusted accordingly.

In some embodiments, a combination of several techniques may be employed. For example, in one of these embodiments, a hash function may be used for the initial mapping, and if necessary, a binary search tree at an entry may be used to differentiate among a plurality of segments mapping to the same entry.

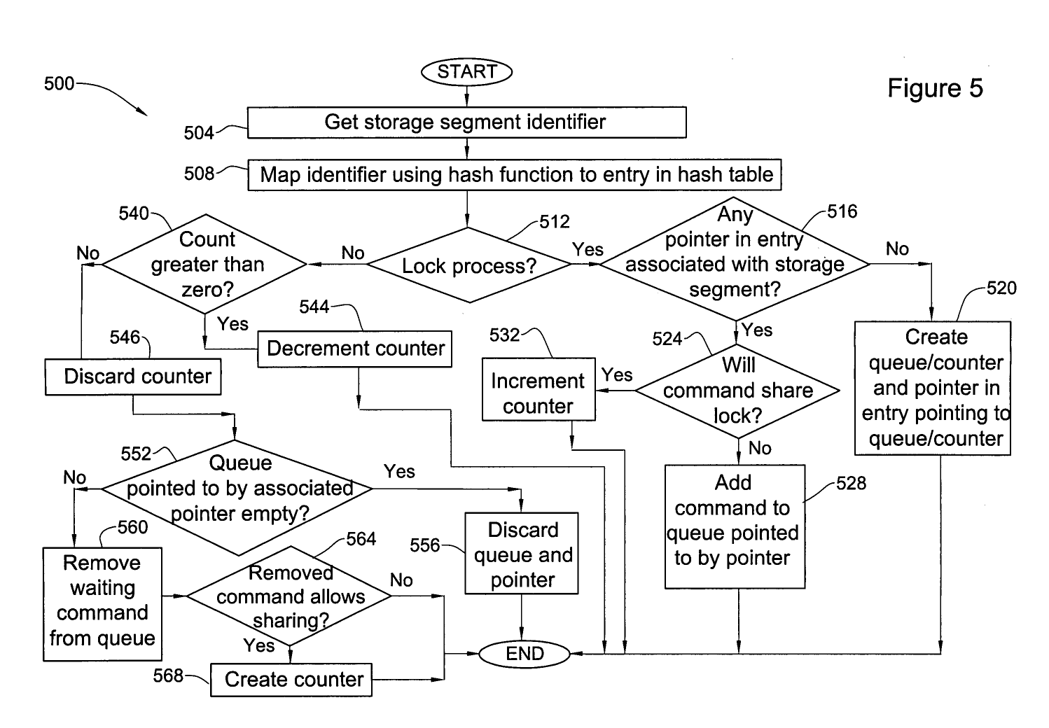

FIG. 5 is a flowchart illustration of a method 500 of managing access to a storage segment, according to some embodiments of the invention. In some cases, method 500 may include fewer, more and/or different stages than illustrated in FIG. 5, the stages may be executed in a different order than shown in FIG. 5, and/or stages that are illustrated as being executed sequentially may be executed in parallel.

In the illustrated embodiments, method 500 is performed by locker/unlocker module 124. For ease of understanding of the reader, performance of various steps are attributed to locator 432, counter manager 436, and/or queue and/or pointer manager 440 but this attribution should not be construed as limiting.

In the illustrated embodiments, it is assumed that locator 432 generates a hash function, although as mentioned above, in other embodiments locator 432 may additionally or alternatively perform another mapping function and/or search utility for locating queues and/or counters.

In the illustrated embodiments of stage 504, locator 432 receives the identifier for a storage segment. For example, locator 432 may receive an identifier each time stage 208 or 304 is executed for a particular storage segment.

In one embodiment the identifier is the address or part of the address of the storage segment but in other embodiments the identifier may be any suitable identifier of the storage segment.

In the illustrated embodiments of stage 508, locator 432 uses a hash function to map the identifier to one of the entries in hash table 458. The hash function is not limited by the invention and can be any suitable hash function, as known to those skilled in the art. For example, assuming hash table includes m entries as illustrated in FIG. 4, locator 432 maps the storage segment identifier to a number between 1 and m.

Assuming numeric identifiers it is noted that in the illustrated embodiments the hash function does not necessarily preserve the sequence of the identifiers. Referring back to FIG. 4, for example, the storage segment identified as 255 is hashed to a lower entry in the hash table (H₄) than the storage segment identified as 124 (which is hashed to Hₘ).

In other embodiments, locator 432 uses another mapping function to map the identifier to an entry in a table, and/or uses a search utility to search a tree for the identifier in addition to or instead of the hash function.

Assuming that the identifier was received during the lock process (for example during stage 208), then in the illustrated embodiments of decision block 516, queue and/or pointer manager 440 checks the entry to which the identifier was mapped to see if the entry contains a pointer 460 associated with the storage segment. Additionally or alternatively, decision block 516 can determine if an entry in a non-hash table to which the identifier was mapped contains a pointer, and/or if any nodes in the search tree are associated with the identifier.

In the illustrated embodiments, it is assumed that if a pointer associated with a storage segment does not exist, the storage segment is unlocked. Therefore, in these embodiments the decision block of 516, where it is determined whether or not the entry includes a pointer associated with the storage segment, is an example of decision block 212 discussed above.

In some embodiments, a pointer associated with a storage segment may exist regardless of whether or not the lock exists on the storage segment. In these embodiments, therefore the existence or non-existence of the pointer does not provide information regarding whether or not the storage segment is locked.

In some embodiments, it is assumed that if a controller associated with the storage segment does not exist, the storage segment is unlocked. Therefore in these embodiments, the additional or alternative determination of whether or not the controller exists is an example of decision block 212 discussed above.

In some embodiments, it is assumed that if a queue associated with the storage segment does not exist, the storage segment is unlocked. Therefore in these embodiments, the additional or alternative determination of whether or not the queue exists is an example of decision block 212 discussed above.

In some embodiments, a counter associated with the storage segment only exists if the command(s) currently holding a lock on the storage segment can share the lock. Therefore in this embodiment, the existence of the counter indicates that the segment is locked and share is allowed, but the non-existence of the counter does not indicate that the segment is not locked (for example in some cases if a write command is holding the lock there may not be a counter).

In some embodiments a counter, queue and/or controller associated with a storage segment may exist regardless of whether or not the lock exists on the storage segment. Alternatively, in another embodiment the counter, queue and/or controller may never exist. In these embodiments, therefore, the existence or non-existence of the counter, queue and/or controller would not indicate whether or not the storage segment is already locked or not.

Assuming embodiments where a search tree is used, in some of these embodiments it is assumed that the non-existence of a node associated with the identifier indicates that the storage segment is unlocked and is therefore an example of decision block 212 discussed above.

In the illustrated embodiment, if a pointer 460 associated with the storage segment does not exist in the entry of hash table 458 to which the identifier was mapped (“no” at decision block 516), then in the illustrated embodiments of stage 520 queue/pointer manager 440 creates a queue 462 and a pointer 460 associated with the storage segment, with the pointer 460 residing in the entry. In the illustrated embodiments, when the command holding the lock can share the lock at least in some cases under the sharing policy, a counter 470 associated with the storage segment may also be created.

In the illustrated embodiments, the created pointer 460 points to the created queue 462, and if created to the created counter 470. Stage 520 is an example of stage 240 discussed above. Method 500 ends after stage 520 is performed.

In other embodiments, one or more controllers associated with the segment may be additionally or alternatively created in stage 520 as an example of stage 240 discussed above. For example if separate individual controllers or pluralities of controllers are responsible for storage segment subsets, then in one embodiment if no segments in the subset are currently locked or have waiting commands, then the individual controller or plurality of controllers responsible for the subset to which the segment belongs may be created.

In other embodiments, only one or two of the queue, counter and pointer may be created as an example of stage 240 described above.

Assuming embodiments where a search tree is used, in some of these embodiments if a tree node associated with the storage segment does not exist, then in stage 520 a tree node is created (in addition to or instead of queue, pointer and/or counter) as an example of stage 240 described above. It is assumed for simplicity of description of the remainder of method 500 that a pointer 460, queue 462 and possibly counter 470 are also created in these embodiments and that the created pointer 460 is held by the node and points to the created queue 462 and to the counter 470 (if created).

In the illustrated embodiments, if there is already a pointer 460 associated with the storage segment (“yes” at decision block 516) and according to the sharing policy the command can share the lock (“yes” at decision block 524), then in the illustrated embodiments of stage 532 counter manager 436 increments the counter 470 pointed to by the pointer 460 associated with the storage segment. Decision block 524 is an example of decision block 220 discussed above. Stage 532 is an example of stage 224 discussed above, with the incrementing of the counter an example of an indication that the lock is being held by an additional command. Method 500 ends after stage 532 is performed.

In the illustrated embodiments, if according to the sharing policy the command will not share the lock (“no” at decision block 524), then in stage 528 queue/pointer manager 440 adds the command to the queue 462 pointed to by the pointer 460 associated with the storage segment in accordance with the wakeup policy. In the illustrated embodiments, queue/pointer manager 440 manages command(s) that are waiting for wakeup to obtain a lock on the segment. The management by queue/pointer manager 440 is not limited by the invention. For example, in one embodiment, queue/pointer manager 440 may manage command and/or controller associated element(s) which were set in the queue as described above. Stage 528 is an example of stage 228 discussed above. Method 500 ends after stage 528 is performed.

Assuming instead that locator 432 received the storage segment identifier as part of the unlock process (for example in stage 304), then at decision block 540 counter manager 436 determines whether or not the count at the counter 470 pointed to by the pointer 460 associated with the storage segment is greater than zero. In the illustrated embodiments, if the count is greater than zero then the lock is currently shared. Decision block 540 is an example of decision block 308 discussed above.

In the illustrated embodiments, if there is a counter associated with the storage segment and the count is greater than zero (“yes” at decision block 540), then in the illustrated embodiments of stage 544, counter manager 436 decrements the counter 470 pointed to by the pointer 460 associated with the storage segment. Stage 544 is an example of stage 312 with decrementing the counter an example of an indication that one less command is holding the lock. Method 500 ends after stage 554 is performed.

In the illustrated embodiments, if there is a counter 470 associated with the storage segment but the count is not greater than zero (“no” at decision block 540), then in the illustrated embodiments of stage 546 counter manager 436 discards the counter associated with the storage segment. Stage 546 is an example of a possible activity performed in stage 316 discussed above. Method 500 then proceeds to decision block 552.

In some embodiments, if there is no counter associated with the storage segment meaning that the lock is exclusive, then method 500 skips directly from a “no” in decision block 512 to decision block 552.

In the illustrated embodiments at decision block 552 it is determined whether or not the queue 462 pointed to by the pointer 460 associated with the storage segment is empty. In the illustrated embodiments, there are no commands waiting for wakeup if the queue is empty. If the queue is not empty (“no” at decision block 552), then in the illustrated embodiments of stage 560 queue/pointer manager 440 removes one or more waiting commands from the queue 462 in accordance with the wakeup policy so that the woken up command(s) can obtain the lock on the storage segment. Stage 560 is an example of stage 320 discussed above.

In the illustrated embodiments, if the removed command(s) allow sharing at least in some cases under the sharing policy (“yes at decision block 564), then in the illustrated embodiments of stage 568, counter manager 436 creates a counter 470 associated with the storage segment and pointed to by the pointer 460 in the entry to which the identifier was mapped. Stage 568 is an example of stage 236 discussed above. Method 500 ends after stage 568 is performed.

If the removed command(s) do not allow sharing (“no” at decision block 564) then method 500 ends.

If instead the queue is empty (“yes” at decision block 552), then in the illustrated embodiments of stage 556, the queue and pointer associated with the storage segment are discarded. In some of these embodiments, the entry to which the identifier was mapped is cleared from any data relating to the storage segment. (It is noted that in some cases, the entry may still contain data relating to other storage segments). Assuming embodiments with a search tree, in one of these embodiments the node of the search tree relating to the storage segment may be discarded and the tree, if necessary, adjusted accordingly.

In some embodiments, the operation of discarding the queue and adding a command to the queue is performed or coordinated by the same controller (for example in queue/pointer manager 440) and therefore a queue will not be discarded if the queue is not empty. However in other embodiments, one or a group of controllers is responsible for checking if the queue is empty and discarding the queue, and another one or group of controllers is responsible for adding a command to the queue. In these latter embodiments, a situation could arise that a command is added to the queue between the check and the discarding. In some of these latter embodiments, various solutions could be applied to rule out this situation, for example commands can be prevented from being added to the queue between the check and the discarding. In another embodiment, one may additionally or alternatively use MUTEX to control all operations related to a queue which will add or remove content from the queue or create or delete a queue related to a storage segment. A controller will be allowed to execute such operation only if it has control of the MUTEX associated with the queue, group of queue or operations. Maintaining a MUTEX over a resource is known to someone skilled in the art.

In one embodiment, assuming dynamic controllers, if the segment was the final segment in the subset for which a controller is responsible which was locked and/or had waiting command(s), the controller may be discarded.

Stage 556 is an example of a possible activity performed in stage 316 above. Method 500 ends after stage 556 is performed.

Although the systems and methods discussed above are not limited in implementation, for the sake of further illustration to the reader, embodiments of one implementation will now be presented. In this implementation, storage 150 is divided among at least three storage entities, including a first solid state storage entity, a second solid state storage entity, and a non-volatile memory non-solid state storage entity. In some of these embodiments, each of the storage entities is associated with one or more separate controllers 120, whereas in other embodiments, controller(s) 120 may be shared among some or all of the storage entities.

Reference is now made to FIG. 6, which is a high level block diagram of an implementation of a system 600 for generating and managing input/output commands, according to some embodiments of the invention. In the illustrated embodiments of the implementation, the storage in system 600 is divided among a first and a second solid state storage entities 610A and 610B, respectively, and a non-volatile memory non-solid state storage entity 630A. Each of the first and the solid state storage entities 610A and 610B may be configured to store data thereon. The non-volatile memory non-solid state storage entity 630A may also be configured to store data thereon. The first solid state storage entity 610A may be operatively connected to the second solid state storage entity 610B, and at least the second solid state storage entity 610B may be operatively connected to the non-volatile memory non-solid state storage entity 630A. According to further embodiments, the storage in system 600 is a mass-storage system. A mass storage system is typically a storage system which is comprised of a plurality of storage devices and associated hardware, firmware and software and that is typically used for enabling storage of a large amount of data. Mass storage systems are typically used by organizations and corporations and are not ideal for home use and other relatively low-level storage needs.

In the embodiments illustrated in FIG. 6 the first and second solid state storage entities are volatile memory storage entities. However in other embodiments the first and/or second solid state storage entity/ies may be non-volatile memory storage entities.

The terms “volatile memory storage” and variants thereof, unless explicitly stated otherwise, are used to describe a component which includes one or more data retention modules whose storage capabilities depend upon sustained power. The terms “volatile-memory storage entity” and variants thereof, unless explicitly stated otherwise, describe a physical and/or logical unit of reference related to volatile memory storage resources. Examples of volatile-memory storage include inter-alia: random-access memory (RAM), dynamic random-access memory (DRAM), static random-access memory (SRAM), Extended Data Out DRAM (EDO DRAM), Fast Page Mode DRAM. Examples of a volatile-memory storage entity include inter-alia: dual in-line memory module (DIMM) including volatile memory integrated circuits of various types, small outline dual in-line memory module (SO-DIMM) including volatile memory integrated circuits of various types, MicroDIMM including volatile memory integrated circuits of various types, single in-line memory module (SIMM) including volatile memory integrated circuits of various types, and including collections of any of the above and various combinations thereof, integrated via a common circuit board, and/or integrated via any type of computer system including any type of server, such as a blade server, for example.

Unless explicitly stated otherwise, the terms “non-volatile memory storage” and variants thereof describe a component which includes one or more data retention modules that are capable of storing data thereon independent of sustained external power. The terms “non-volatile-memory storage entity” and variants thereof, unless explicitly stated otherwise, describe a physical and/or logical unit of reference related to non-volatile storage resources. Examples of non-volatile memory storage include inter-alia: magnetic media such as a hard disk drive (HDD), FLASH memory or FLASH drives, Electrically Erasable Programmable Read-Only Memory (EEPROM), battery backed DRAM or SRAM optical media such as CDR, DVD, and Blu-Ray Disk, and tapes. Examples of a non-volatile memory storage entity include inter-alia: Hard Disk Drive (HDD), Flash Drive, some types of Solid-State Drive (SSD), and tapes.

The terms solid state storage and variants thereof, unless explicitly stated otherwise, refer to storage based on the semiconductor. The terms “solid state storage entity” and variants thereof, unless explicitly stated otherwise, describe a physical and/or logical unit of reference related to solid state storage resources. The terms “non-solid state storage” and variants thereof, unless explicitly stated otherwise, describe storage which is not based on the semiconductor. The terms “non-solid state storage entity” and variants thereof, unless explicitly stated otherwise, describe a physical and/or logical unit of reference related to non-solid state storage resources. Examples of solid state include inter-alia, FLASH memory or FLASH drives, Electrically Erasable Programmable Read-Only Memory (EEPROM), battery backed DRAM or SRAM. Examples of non-solid-state storage includes, inter alia, magnetic storage media, such as hard disk drive (HDD) and optical media such as CDR, DVD, and Blu-Ray Disk.

As is shown in FIG. 6 and according to some embodiments of the invention, the storage entities in system 600 include an array of solid state storage entities 610A-610N and the first and the second solid state storage entities 610A and 610B may be part of the array. Similarly, as is shown in FIG. 6 and according to some embodiments of the invention, the storage entities in system 600 include an array of non-volatile memory non-solid state storage entities 630A-630M and the storage entity 630A may be part of the array.

In the illustrated embodiments of FIG. 6, each one of the solid state storage entities 610A-610N in system 600 may be operatively connected to a solid state storage controller 640. The solid state storage controller 640 may be operatively connected to one or more hosts 650. In another embodiment, each solid state storage entity may be associated with a separate solid state storage controller, or there may be two or more solid state storage controllers 640, each associated with a plurality of solid state storage entities. In the illustrated embodiments, system 600 also includes a non-volatile memory non-solid state storage controller 660 which may be configured to manage the storage and retrieval of data to and from the non-volatile memory non-solid state storage entities 630A-630M. It should be noted that in various embodiments, the same controller or controllers may be associated with the first solid state storage entity 610A, the second solid state storage entity 610B and/or the non-volatile memory non-solid state storage entity 630A, or each storage entity may be associated with a separate controller.

In some embodiments of the implementation, in operation, when a write command is issued by a host 650, a data element which is the subject of the command is stored on first solid state storage entity 610A. The data element comprises a set of bits or bytes, with the number of bits or bytes in the set not limited by the invention. In addition, recovery enabling data corresponding to the data element is stored on the second solid state storage entity 610B. Once the recovery enabling data is stored, a write acknowledgement is returned to the issuing host 650. At any time after the write acknowledgement is returned to host 650, a controller associated with the second solid state storage entity, for example solid state storage controller 640, issues a write command, causing a copy of the recovery enabling data to be stored on non-volatile memory non-solid state storage entity 630A .

In one of these embodiments, the controller issues the write command substantially immediately upon storage of the recovery enabling data on second solid state storage entity 610B. However, in other embodiments, the write command may be delayed, for example to allow completion of a priority operation or a priority sequence that is concurrently pending or that is concurrently taking place within the system. In one of these embodiments, a limited duration delay is allowed.

Depending on the embodiment, a write acknowledgment may or may not be returned after a copy of the recovery enabling data is stored on non-volatile memory non-solid state storage entity 630A. Also depending on the embodiment, removal (for example by deletion, copying over, etc) of the recovery enabling data on the second solid state storage entity may or may not be allowed after a copy has been stored on the non-volatile memory non-solid state storage entity.

Unless explicitly stated otherwise, the term “recovery-enabling data” or variants thereof describe certain supplemental data that is stored in storage in system 600 possibly in combination with one or more references to data elements which are part of the current data-set of the storage in system 600 and which (collectively) enable(s) recovery of a certain (other) data element (D) that is part of the data-set of the storage in system 600. Each recovery-enabling data-element (R) may be associated with at least one original data element (D) which is part of the current data-set of the storage in system 600. Each recovery-enabling data-element (R) may be usable for enabling recovery of the original data element (D) with which it is associated, for example, when the original data (D) is lost or corrupted. A recovery-enabling data-element (R) may enable recovery of the corresponding data element (D) based on the data provided by recovery-enabling data (R) (e.g., the supplemental data with or without references to other data elements) and the unique identity of the respective data element which is to be recovered. Examples of recovery-enabling data may include inter-alia: a mirror of the data element (the supplemental data associated with a data elements is an exact copy of the data element—no need for references to other data elements); parity bits (the supplemental data associated with a data element are the parity bits which correspond to the data element and possibly to one or more other data elements and with or without references to the data element and to the other data elements associated with the parity bits); error-correcting code (ECC). It would be appreciated that while in order to recover a certain data element, in addition to certain supplemental data (e.g., parity bits), references to the other data elements may in some cases be required, the references to the other data elements may be obtained by implementing an appropriate mapping function (or table) and thus, the recovery-enabling data may not be required to include the reference to the other data elements associated with the supplemental data. However, in other cases, each recovery-enabling data element (e.g. parity bits) may include references to each data element that is associated with the respective recovery-enabling data element.

Unless specifically stated otherwise, the term “current data-set of the storage” and variants thereof shall be used to describe a collection of data elements which together constitute at least one current-copy of the entire data which is stored within the storage by I/O command generator(s) at any given point in time. It would be appreciated that the data-set of the storage may change over time and may evolve dynamically. For example, between two instants the data-set of the storage may undergo changes, for example, as a result of I/O activity, and thus the data-set of the storage at the first instant may differ from the data-set of the storage at the second instant. It would be further appreciated that in a storage, in addition to the data-set which constitutes a copy of the entire data stored within the storage I/O by command generator(s), other data may be stored, including, but not limited to, metadata, configuration data and files, maps and mapping functions, recovery-enabling data and backup data, etc.

In accordance with some embodiments of this implementation described above, two write commands are issued, the first by host 650 and the second by a controller associated with second solid state storage entity 610B (for example solid state storage controller 640). Therefore depending on the embodiment, in this implementation, the host and/or the controller associated with the second solid state storage is/are example(s) of I/O command generator 104.

In one embodiment of this implementation, the k storage segments which are locked in method 200 may be located in first solid state storage entity 602A. These k storage segments are locked by a controller associated with the first solid state storage entity so that the data element that is subject to the write command issued by host 650 can be completely written, without hindrance by other commands accessing the first solid state storage entity. In this embodiment, host 650 is an example of command generator 104, the first solid state storage entity 610A is an example of a storage entity including storage 150, and the controller associated with the first solid state storage entity (for example solid state storage controller 640) is an example of controller 120. In another embodiment of this implementation, the k storage segments which are locked in method 200 may be located in the second solid state storage entity 610B. These k storage segments are locked by a controller associated with the second solid state storage entity so that the recovery enabling data can be completely written without hindrance by other access to the second solid state storage entity. In this embodiment, host 650 is an example of command generator 104, the second solid state storage entity 610B is an example of an entity including storage 150 and the controller associated with the second solid state storage entity (for example solid state storage controller 640) is an example of controller 120. In another embodiment, the k storage segments which are locked in method 200 include both segments on the first solid state storage entity 610A which will hold the data element and segments on the second solid state storage entity 610B which will hold the recovery enabling data. In this embodiment, the first and second solid state storage entities 610A and 610B are examples of entities including storage 150, the controller associated with the first and second solid state storage entities 610A and 610B (such as solid state storage controller 640) is an example of controller 120 and host 650 is an example of command generator 104. In another embodiment of this implementation, the k storage segments that are locked in method 200 are located on the non-volatile memory non-solid state storage entity 630A. These k storage segments are locked by a controller associated with the non-volatile memory non-solid state storage entity so that a copy of the recovery enabling data that is subject to the write command issued by the controller associated with the second solid state storage entity can be completely written without hindrance by other commands accessing the non-volatile memory non-solid state storage entity. In this embodiment, a controller associated with the second solid state storage entity (for example solid state storage controller 640) is an example of command generator 104, the non-volatile memory non-solid state storage entity 630A is an example of an entity including storage 150 and the controller associated with the non-volatile memory non -solid state storage entity (for example non-volatile memory non-solid state storage controller 660) is an example of controller 120.

Assuming an implementation where there is a first solid state storage controller associated with first solid state storage entity 610A and a second solid state storage controller associated with second solid state storage entity 610B (rather than the same solid state storage controller associated with both), then in some embodiments, after receiving the write command from host 650, the first solid state storage controller sends a write command to the second solid state storage controller. In one of these embodiments, the second solid state storage controller locks storage segments in second solid state storage entity 610B so that the recovery enabling data can be completely written without hindrance by other access to second solid state storage entity 610B. In this embodiment, the first solid state storage controller is an example of command generator 104, the second solid state storage controller is an example of controller 120 and second solid state storage entity 610B is an example of an entity including storage 150.

In some embodiments a write command relates directly to one or more segments in one storage entity and indirectly to one or more segments in another storage entity. For example, host 650 may issue a write command for the data element which will be written on first solid state storage entity and therefore segment(s) in first solid state storage entity 610A which are directly related to the command will need to be locked before performing the write command. However in this example, because recovery enabling data will need to be written to second solid state storage entity, segments in second solid state storage entity 610B which are indirectly related to the command will also need to be locked before performing the write command.

It will be appreciated, that in some embodiments of implementation the illustrated system in FIG. 6, there is a tight coupling between storage segments in two or more different storage entities. This coupling determines that a command or series of commands will always operate first on segments in one particular storage entity and only then on segments in any of the other storage entities. In some of these embodiments, therefore, as long as segments in the particular storage entity are locked, the segments in the other coupled storage entities are effectively locked and do not need to be independently locked. In one of these embodiments, if the particular storage entity is no longer available for any reason, then segment(s) in one or more of the other storage entities would need to be independently locked prior to command performance.

As an example of embodiments with tight coupling, assume an embodiment where there is a tight coupling between first solid state storage entity 610A and second solid state storage entity 610B. This coupling determines that when a write command is received, first the data element will be written to first solid state storage entity 610A , and then the recovery enabling data will be written to second solid state storage entity 610B. Since the two are tightly coupled and only accessed in this manner, locking the segment(s) in first solid state storage entity 610A will imply that segment(s) in second solid state storage entity 610B are effectively locked as well

As another example of embodiments with tight coupling, alternatively or additionally assume an embodiment where there is a tight coupling between second solid state storage entity 610B and non-volatile memory non-solid state storage entity 630A. This coupling determines that recovery enabling data is first written to second solid state storage entity 610B and then a copy of the recovery enabling data is written to non-volatile memory non-solid state storage entity 630A. Since the two are tightly coupled and only accessed in this manner, locking segment(s) in second solid state storage 610B will imply that segment(s) in non-volatile memory non-solid state storage entity 630A are effectively locked as well.

As another example of embodiments with tight coupling, alternatively or additionally assume embodiments where there is a tight coupling between first solid state storage entity 610A and second solid state storage entity 610B and a tight coupling between second solid state storage entity 610B and non-volatile memory non-solid state storage entity 630A. In one of these embodiments, locking segments in first solid state storage entity 610A will imply that segment(s) in second solid state storage entity 610B and non-volatile memory non-solid state storage entity 630A are effectively locked as well.

Referring again to FIG. 6, in the illustrated embodiments, solid state storage controller 640 holds a map of the permanent storage space 641. The permanent storage space is comprised of the aggregate of all physical storage resources within the storage in system 600 that are allocated for substantially permanently storing data within the storage. The aggregate of all solid state physical storage resources within the storage in system 600 that are allocated for substantially permanently storing data within the storage, or some portion thereof, may collectively be configured to substantially permanently hold the entire (current) data-set of the storage in system 600. In these embodiments, the solid state storage controller 640 also includes a mapping module 642 which is configured to implement a mapping function.

In the illustrated embodiments, solid state storage controller 640 may hold a map of temporary storage space 644 (in addition to the map of the permanent storage space 41). The map of the temporary storage space 644 specifies the solid state storage resources on each of the solid state storage entities 610A-610N that are associated with the solid state storage controller 640 and which are allocated for temporary storage of data within the storage in system 600, for example for recovery enabling data. As an alternative to the dynamically updating map of temporary storage space 644, a dynamically updating look-up-table 646 may be provided as a supplement to a static map of temporary storage space 644.

In the illustrated embodiments, as mentioned above, non-volatile memory non-solid state storage controller 660 may be configured to manage the storage and retrieval of recovery-enabling data to and from the non-volatile memory non-solid state storage entities 630A-630M. In the illustrated embodiments, non-volatile memory non-solid state storage controller 660 may hold a map of the non-volatile non-solid state storage space 661. According to some embodiments of the invention, the non-volatile memory non-solid state storage controller 660 may include a mapping module 662 and/or a mapping function.

In the illustrated embodiments, system 600 includes a recovery controller 670. The recovery controller 670 may be configured to control data-recovery operations within system 600. In the illustrated embodiments, recovery controller 670 includes a recovery-enabling data reference table 672.

In the illustrated embodiments, system 600 includes a local recovery controller 680 on the solid state storage entity which is or was originally used to store the recovery-enabling data. In the illustrated embodiments, the local recovery controller 680 may include a local recovery table 682 which is dynamically updatable, or some other appropriate dynamic data structure.

In the illustrated embodiments, system 600 includes one or more Uninterruptible Power Supply (UPS) units 690A-690N. Each UPS unit may be configured to enable uninterruptible power to various components of the storage in system 600. In embodiments where all storage is non-volatile, UPS units 690A-690N may be omitted.

In some embodiments, the storage in system 600 may be divided over a plurality of servers. In some of these embodiments, each one of the plurality of servers may include solid state storage resources and non-volatile memory non-solid state storage resources. According to some of these embodiments, a copy of each of: solid state storage controller 640, recovery controller 660 and non-volatile memory storage controller 670 may be implemented on each one of the servers. However in other embodiments two or more servers may share a particular controller.

Assuming embodiments with a plurality of servers, in some of these embodiments the data element and the recovery enabling data are stored on separate servers. For example, assuming the data element is stored on first solid state storage entity 610A which is located on a particular server, in one embodiment recovery enabling data will be stored on a second solid state storage entity 610B which is located on a different server than the particular server. Continuing with the example, additionally or alternatively, in one embodiment a copy of the recovery enabling data will be stored on non-volatile memory non-solid state storage entity 630A which is located on a different server than the particular server. It can be appreciated that in some cases, storage of the data element and recovery enabling data on separate servers reduces the risk of losing both the data element and the recovery enabling data.

It will also be understood that in some embodiments the system or part of the system according to the invention may be a suitably programmed computer. Likewise, some embodiments of the invention contemplate a computer program being readable by a computer for executing a method of the invention. Some embodiments of the invention further contemplate a machine-readable memory tangibly embodying a program of instructions executable by the machine for executing a method of the invention.

While certain features of the invention have been illustrated and described herein, many modifications, substitutions, changes, and equivalents will occur to those skilled in the art. It is therefore to be understood that the appended claims are intended to cover all such modifications and changes as fall within the true scope of the invention.

1. A method of managing input/output commands comprising:
in a predetermined order, attempting to obtain a lock for a received input/output command on all of a plurality of storage segments relating to said command;
if during said attempting a lock cannot be obtained on a storage segment in said plurality because of an already existing lock which will not be shared with said command, then waiting until a lock can be obtained for said command and after obtaining said lock, attempting to obtain a lock on a next storage segment in said predetermined order;
wherein said command is performed only after a lock has been obtained for said command on all of said plurality of storage segments.

2. The method of claim 1, wherein said predetermined order is according to ascending addresses of said plurality of storage segments.

3. The method of claim 1, further comprising:
unlocking at least one of said plurality of storage segments.

4. The method of claim 1, wherein more than one command is waiting for said lock, and said command obtains said lock because of a longer wait time than any other waiting command.

5. The method of claim 1, wherein said input/output command and another command are non-content changing commands, said attempting including:
sharing a lock on a storage segment in said plurality with said other command.

6. The method of claim 5, further comprising:
checking if a number of content changing commands waiting for a lock on said storage segment is less than a predetermined ceiling, and sharing a lock on said storage segment only if said number is less than said ceiling.

7. The method of claim 6, wherein said ceiling is one.

8. The method of claim 6, further comprising: incrementing a counter when a command begins sharing a lock on a storage segment and decrementing a counter when a command stops sharing a lock on said storage segment .

9. The method of claim 1, wherein for at least one storage segment in said plurality, said attempting includes:
hashing an identifier of said storage segment in order to determine an associated entry in a hash table;
checking if said associated entry includes a pointer corresponding to said storage segment;
if said associated entry does not include a pointer corresponding to said storage segment, generating a pointer associated with said storage segment, wherein said pointer is located in said entry.

10. The method of claim 9, wherein said identifier includes at least part of an address of said storage segment.

11. The method of claim 9, further comprising: if said associated entry does include a pointer corresponding to said storage segment, queuing said input/output command in a queue pointed to by said pointer.

12. The method of claim 9, further comprising:
after performing said input/output command, discarding an empty queue associated with a storage segment in said plurality which is not currently locked by one or more other commands.

13. The method of claim 1, wherein for at least one storage segment in said plurality, said attempting includes:
searching a search tree to determine if said tree includes a node associated with an identifier of said storage segment ;
if no such node exists, adding a leaf node to said search tree and generating a pointer associated with said storage segment, wherein said pointer is located in said leaf node.

14. The method of claim 13, wherein said identifier includes at least part of an address of said storage segment.

15. The method of claim 13, further comprising: if such a node exists, queuing said input/output command in a queue pointed to by a pointer located in said node.

16. The method of claim 13, further comprising:
after performing said input/output command, discarding an empty queue and a node associated with a storage segment in said plurality which is not currently locked by one or more other commands.

17. The method of claim 1, wherein at least one of said plurality of storage segments collectively stores or will store a data element subject to said input/output command.

18. The method of claim 1, wherein at least one of said plurality of storage segments collectively stores or will store recovery enabling data relating to a data element which is subject to said input/output command.

19. The method of claim 1, wherein at least one of said plurality of storage segments is associated with at least one solid state storage entity.

20. The method of claim 1, wherein at least one of said plurality of said storage segments is associated with a non-volatile memory non-solid state storage entity.

21. The method of claim 1, wherein said plurality of storage segments directly relate to said command.

22. The method of claim 1, wherein at least one of said plurality of storage segments indirectly relates to said command.

23. A system for managing input/output commands comprising:
at least one storage comprising storage segments; and
at least one controller configured to receive input/output commands generated by at least one command generator, and for each input/output command configured to attempt to obtain a lock on all of a plurality of storage segments related to said command in a predetermined order, and if during said attempting a lock cannot be obtained on a storage segment in said plurality because of an already existing lock which will not be shared with said command, then further configured to wait until a lock can be obtained for said command and after obtaining said lock, to attempt to obtain a lock on a next storage segment in said predetermined order; said at least one controller further configured to perform said command after a lock has been obtained on all storage segments related to said command.

24. The system of claim 23, wherein said system includes a counter, configured to keep count of a number of commands sharing a lock on a storage segment in said at least one storage.

25. The system of claim 23, wherein said system includes a table or search tree, configured to hold at least one pointer to at least one queue associated with at least one storage segment in said at least one storage.

26. The system of claim 23, wherein said system is configured to generate a hash function of an identifier of a storage segment in said storage in order to identify an entry in a hash table, and to generate a pointer associated with said storage segment if not yet existing, wherein said pointer is located in said entry.

27. The system of claim 23, wherein said system is configured to search a search tree for an identifier of a storage segment in said storage and to generate a node associated with said storage segment, if not yet existing, on said tree,

28. The system of claim 23, wherein said at least one storage is divided among at least first and second solid state storage entities and a non volatile memory non-solid state storage entity.

29. The system of claim 28, wherein
said first solid state storage entity is configured to store data thereon and responsive to a write command related to a data element for storing a first copy of said data element;
said second solid state storage entity is configured to store data thereon and responsive to said write command related to said data element for temporarily storing recovery-enabling data corresponding to said respective data element;
said non-volatile memory non-solid state storage entity is configured to store data thereon and operatively connected to at least said second solid state storage entity,
and wherein a controller among said at least one controller which is associated with said second solid state storage entity is further configured to issue a write command for causing said non-volatile memory non-solid state storage entity to store a copy of recovery-enabling data thereon, and
wherein said controller which is associated with said second solid state storage entity is further configured to initiate the write command substantially immediately upon storage of the recovery-enabling data on said second solid state storage entity.

30. The system of claim 28, wherein at least one of said second solid state storage entity and said non-volatile memory non-solid state storage entity is on a different server than said first solid state storage entity, so that said data element is stored on a separate server than at least one of said recovery-enabling data and said copy of said recovery-enabling data.

31. The system of claim 28, wherein said system is configured to obtain a lock on a segment in first solid state storage entity, effectively locking a segment on said second solid state storage entity or on said non-volatile memory non-solid state storage entity.

32. The system of claim 30, wherein if said first solid state storage entity fails, then said system is configured to independently obtain a lock on said segment in said second solid state storage entity or non-volatile memory non-solid state storage entity.

33. A program storage device readable by machine, tangibly embodying a program of instructions executable by the machine to perform a method of managing input/output commands comprising:
in a predetermined order, attempting to obtain a lock for a received input/output command on all of a plurality of storage segments relating to said command;
if during said attempting a lock cannot be obtained on a storage segment in said plurality because of an already existing lock which will not be shared with said command, then waiting until a lock can be obtained for said command and after obtaining said lock, attempting to obtain a lock on a next storage segment in said predetermined order;
wherein said command is performed only after a lock has been obtained for said command on all of said plurality of storage segments.

34. A computer program product comprising a computer useable medium having computer readable program code embodied therein of managing input/output commands the computer program product comprising:
computer readable program code for causing the computer to in a predetermined order, attempting to obtain a lock for a received input/output command on all of a plurality of storage segments relating to said command;
computer readable program code for causing the computer to if during said attempting a lock cannot be obtained on a storage segment in said plurality because of an already existing lock which will not be shared with said command, then waiting until a lock can be obtained for said command and after obtaining said lock, attempting to obtain a lock on a next storage segment in said predetermined order;
computer readable program code for causing the computer to wherein said command is performed only after a lock has been obtained for said command on all of said plurality of storage segments.
